(19) United States
(12) Patent Application Publication
(10) Pub. No.: US 2009/0132579 A1
(43) Pub. Date: May 21, 2009

(54) SESSION AUDIT MANAGER AND METHOD

(76) Inventor: Edward M. Kwang, Walnut, CA (US)

Correspondence Address: CHAN LAW GROUP LC, 1055 W. 7TH ST,, SUITE 1880, LOS ANGELES, CA, 90017, US

(21) Appl. No.: 11/943,839

(22) Filed: Nov. 21, 2007

(51) Int. Cl. G06F 15/173; G06F 17/30

(52) U.S. Cl. 707/102; 709/224; 707/E17.044

(57) ABSTRACT

A system and method is for managing user session usage on one or more network devices. A session audit agent executes on each of the one or more network devices for collecting application usage data. A session audit services application executes on the one or more network devices for receiving the application usage data from each session audit agent. A session audit web service system executes on a web server that is capable of receiving the application usage data from the session audit service. A session audit manager (SAM) for receives the application usage data from the session audit web service. One or more session usage audit tools is provided as part of the session audit manager for monitoring and analyzing user session usage of the one or more network devices.

A session audit manager and method is disclosed. Specifically, a session audit manager measures usage and efficiency of uses in a local or wide area network.

### BACKGROUND OF THE INVENTION

Since the introduction of the personal computer in the early 1980's, the PC has been subject to constant change, ever increasing in capability and usage. From its earliest form in which the data accessible was limited to that which the user could load from a floppy disk to the typical gigabyte hard drives common on PCS today, the amount of data and the ease of obtaining this data have been growing rapidly. With the fruition of the computer network, the available data is no longer limited to the user's system or what the user can load on his system. Local Area Networks or LANs are now common in small businesses, and in such networks users may, in addition to their own local data, obtain data from other local stations as well as data that is available on the local server. Corporate networks and internets may connect multiple LANs, thereby increasing the data available to users. Larger still are Wide Area Networks (WANs) and Metropolitan Area Networks (MANs), the latter of which is designed to cover large cities.

The largest such network, commonly known as the Internet, has introduced vast amounts of information into the business place and the home. The individual networks that make up the Internet include networks which may be served from sources such as commercial servers (.com), university servers (.edu), research networks (.org, net), and military networks (.mil). These networks are located throughout the world and—their numbers are ever increasing with an estimated 85,000 new domain registrations presently occurring each month with countless Internet sites spawned from these domains.

With the exponential growth of the Internet and the explosion of interest worldwide, one natural consequence of this profundity is a growing diversity in the subject matter of the available information. Although this was the original intent of the Internet developers, there are obvious disadvantages and undesirable consequences of such a global information exchange. What is quickly becoming a notorious example of such occurrence is the proliferation of pornography, hate materials, and other materials, some of which may not only be offensive, but illegal.

A specific difficulty encountered with the introduction of this powerful informational tool in the business and home is the logistical problem of governing the usage of the available data to specific users. In a corporate environment with access to, for example, the Internet, it is obviously advantageous for management to be able to limit or monitor in some fashion their employees' usage of such a resource not only to ensure productivity but to prevent liability for inappropriate employee Internet activities. Likewise, in the home, a parent may desire to have the beneficial educational information that exists in great quantity on the Internet available for his child, but, at the same time, may wish to prevent that child from accessing inappropriate materials, either by intent or accident.

In the discussion that follows, operator will refer to the person attempting to monitor or block another person's activity on a computer system by any method or means. User will refer to the person whose computer activity is subject to being monitored or blocked.

Currently, those companies with the financial resources desiring the efficiency of exchanging information through the Internet may elect to use an intranet, e.g., a LAN. This way, the company can distribute information to its employees with the conveniences of the Internet, but without actually being connected to the Internet. The company may also either block specific domains from access by its employees, or give access to only specified domains. This may be achieved by appropriate software or coding to block domains at a gateway or firewall. However, these methods may not be financially or technically feasible, or this may not serve the company's intent in any regard. Also, this technique does not prevent employees from loading computer games on their computer and playing them during work hours. Often, a company may desire that its employees have unlimited access to data resources through the Internet with the only restriction being that their access is useful for fulfilling the duties of their jobs. In this instance, it would be counterproductive to give access to only certain domains, as doing so would block access to future domains that may provide information beneficial to serving well an employee's position.

Commercially available applications to help combat this problem on the home or business PC are well known, such as Net Nanny™, Surf Watch™, and NetSnitch™. These applications and their respective limitations are now discussed.

Net Nanny™ is a software utility marketed to control, primarily, children's access to offensive Internet sites. This software's primary functionality is the use of an operator-defined, customized dictionary of terms or phrases to be blocked from access. In operation, Net Nanny™ performs a system shutdown whenever any material matching criteria in the operator-defined dictionary is accessed. This product works offline as well as online and performs a system shutdown when material matching specified criteria are accessed, where the material to be blocked could be loaded from floppy disks, CD-ROMS, local hard drives, network drives, or any other appropriate media. It can also be configured to provide the user a warning or to create a log of “offences”—accesses to material that have been defined as offensive in the customized dictionary. Specific sites are also able to be blocked by the software operator, and similarly, the operator may make only certain sites available to be accessed.

Although this specific, operator-defined approach is somewhat useful, a number of limitations are apparent. For example, in utilizing a customized dictionary to block sites by keyword, the operator is responsible for formulating a list of words or phrases that could be included on a site with offensive material. Any descriptive phrases or terminology overlooked or unknown by the operator may therefore be readily available to the user. In addition, material deemed offensive to the operator is not necessarily described on a website by offensive descriptive words that would be detected by the blocking software. For example, pornographic material may be served from a server in a numeric index format. In this case, graphic files may be sequentially numbered with no descriptive text on that site. In this instance, it would not be possible for the blocking software to detect the presence of the offensive graphic material. The same case would be true when operating the blocking software offline. Unless a graphic file, for instance, was named with a title that matched an offensive criteria, the file could be viewed without generating a detection by the blocking software.

SurfWatch™ is another program designed to block children's or employees' access to offensive Internet sites. It is intended to solely block offensive Internet sites and is therefore utilized only for online activities. Primarily, it relies on blocking sites by use of a database that contains sites that have been determined to be offensive and by the use of keyword filters. The database is periodically updated and is available through a service with payment of a licensing fee. Through the licensing agency, criteria have been established as to what material is deemed offensive, which includes, but is not limited to, sexually explicit, violent, and/or illegal drug information. The software operator has configuration options available to alter the criteria by which Internet sites are blocked.

Again, the limitations are obvious. By relying on a licensing agent to develop updated databases of offensive sites, the operator is reliant on the agent to determine or locate any and all such sites containing material that is offensive. At best, the agent would be able to eliminate a large majority of such sites. It would not be reasonable, however, to expect such an agency to be able to locate every possible such site.

Additionally, there would exist a necessary delay in the creation of a new site containing offensive material and the time at which it is detected by the licensing agency and updated in the database of blocked sites. During that time, any user utilizing a system with the blocking software implemented by an operator would have unrestricted access to that site, assuming that the site did not contain descriptors matching those in the filtering module of the software.

A further problem of such a blocking method is that the operator is relying on a third party, the licensing agency, to concur with the operator in the subjective determination of what material is offensive. This method, in its most fundamental aspect, removes from the operator the ability to censor objectionable material as deemed objectionable by the operator. This limits the control of the operator to the task of formulating descriptive terms and phrases to be used by the filtering module, a method similar to and with limitations consistent with the previously discussed prior art application.

Another commercially available application is NetSnitch™ which does not actively block Internet sites, as the previously discussed art does, but instead creates a log of Uniform Resource Locators (URLs) that can later be reviewed and loaded by the software operator to determine what type of Internet sites have been visited by the user. It is designed to function online and, therefore, its usefulness is limited to online activities. When the user goes online, a log is activated which lists the specific Internet sites the user visits by recording that site's URL. It is, therefore, used as a monitor of user activity by allowing the software operator to later retrieve the log, and if desired, to go online and load the URLs one at a time to investigate what type of content is contained at the sites accessed by the user. As is apparent, this method does not offer any type of site blocking but gives, in one form, a complete history of the user's activity online, which is recorded by each site's URL.

An obvious limitation of this method, however, is that it only works online. Offensive material may be loaded by floppy disk, for example, and viewed without the monitoring software ever being activated. Furthermore, for the operator to determine the user's online activity history, it is necessary for the operator to go online him or herself, and load each URL to investigate the material at each site, a time consuming and inconvenient task. Also, none of the above techniques is able to verify the user's actual activities, e.g., the content of a user's discussion in an on-line “chat-box,” which can be pornographic, racial or hate related.

It is, therefore, evident that the need exists for a convenient system and method for monitoring a computer user's activity by an operator, while not limiting the user's computing or informational allowances. Although a great deal of today's PC users' data is generated from Internet usage, it has been established that a need exists for a software application to be effective offline, as well as online. It is further desired that no limitations be placed on what type of material is to be monitored and for the application to take no action against the user and, additionally, for the application to give no suggestion to the user of the application's operation. In doing so, the operator would have sole discretion as to what type of usage is objectionable or offensive and as to what course of action should be taken.

There is a further need for a system and method that performs this monitoring locally, over a local area network (LAN), or over a wide area network (WAN). There is a further need for a system and method that performs this monitoring by collecting data for later analysis, or in real time while users are working on their computers.

### SUMMARY OF THE INVENTION

In a preferred embodiment, a system and method is for managing user session usage on one or more network devices. A session audit agent executes on each of the one or more network devices for collecting application usage data. A session audit services application executes on the one or more network devices for receiving the application usage data from each session audit agent. A session audit web service system executes on a web server that is capable of receiving the application usage data from the session audit service. A session audit manager (SAM) for receives the application usage data from the session audit web service. One or more session usage audit tools is provided as part of the session audit manager for monitoring and analyzing user session usage of the one or more network devices.

### BRIEF DESCRIPTION OF THE DRAWINGS

FIG. 1 is a high level block diagram illustrating components of a networked system according to one embodiment;

FIG. 2 is a flow diagram illustrating steps performed by the system audit agent (SAA) of FIG. 1;

FIG. 3 is a data flow diagram that describes steps performed by the SAA to notify the session audit services application (SAS) of FIG. 1 when a user session starts;

FIG. 4 is a flow diagram that describes the steps performed by the SAA to send updates to the SAS about current user session;

FIG. 5 is a flow diagram that describes the steps performed by the SAA to notify the SAS that a user session ends;

FIG. 6 is a flow diagram that illustrates the steps performed by the SAA to capture process detail;

FIG. 7 is a flow diagram illustrating steps performed by the SAS;

FIG. 8 is a flow diagram that describes the steps performed by the SAS to process a session start request;

FIG. 9 is a flow diagram that describes steps performed by the SAS to process a session update request;

FIG. 10 is a flow diagram that illustrates the steps performed by the SAS to process a session end request;

FIG. 11 is a flow diagram that illustrates the steps performed by the SAS to synchronize user session data with the session audit web services system (SAWS) of FIG. 1;

FIG. 12 is a flow diagram that illustrates the steps performed by the SAS to send data to SAWS;

FIG. 13 is a flow diagram that describes steps performed by the SAWS;

FIG. 14 is a data flow diagram that illustrates steps performed by the SAWS to process update data requests;

FIG. 15 is a data flow diagram that illustrates the steps performed by the SAWS to allow the SAM to retrieve data from a centralized database;

FIG. 16 illustrates the steps performed by the SAM according to one embodiment and procedure;

FIG. 17 presents a database schema according to one embodiment;

FIG. 18 is screen shot of a real-time window presented by a session audit manager program according to one embodiment;

FIG. 19 is a screen shot of a historical view date range selection screen according to one embodiment;

FIG. 20 is a screen shot of a historical view window with detail activities of a highlighted user session presented by the session audit manager program according to one embodiment;

FIG. 21 is a screen shot of a statistical summary screen at “Status” level of a highlighted user session presented by the session audit manager program according to one embodiment;

FIG. 22 is a screen shot of a statistical summary screen at “Status” and “Application” level of a highlighted user session presented by the session audit manager program according to one embodiment; and

FIG. 23 is a screen shot of a statistical summary screen at “Status” and “Application” level of a highlighted user session, with drill down to detail of a particular note, presented by the session audit manager for application window usage for particular application program.

### DETAILED DESCRIPTION OF THE PREFERRED EMBODIMENTS

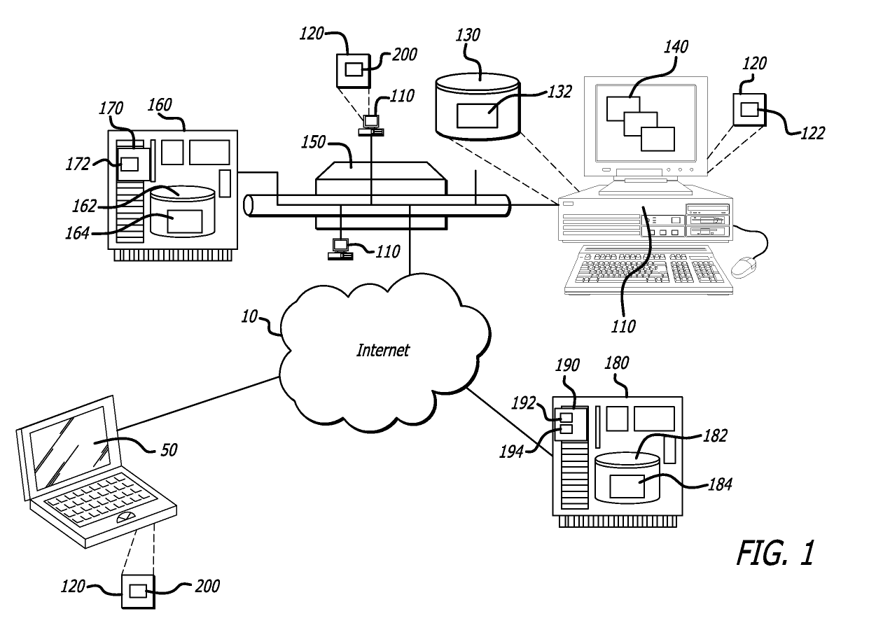

Briefly, and in general terms, the claimed invention resolves the above and other problems by providing a system audit manager and method. According to an embodiment of the invention, the system can be used in a network such as one depicted by the block diagram according to FIG. 1. Even though the implementation described in this embodiment is based on Microsoft Windows Operation System, the system and method described here can be applied to other operating system as well. In one embodiment, a system audit agent (SAA) 122 is installed as an executable set of software instructions in each of the memories 120 of one or more network devices, personal computers or client work stations 110. In one embodiment, the SAA 122 collects application usage data and generates a window change event log file 132 in a local storage medium 130 when SAA can't communicate with a session audit services application (SAS) 172 described below. To preserve the data collected by SAA under this kind of condition, the data is saved to the log file 132. As soon as the communication between SAA 122 and SAS 172 is restored, the log file will be cleared.

In one embodiment, a window change event comprises either a new window being opened in a graphical user interface executing on the work station 110. The SAA 122 polls all open windows 140 executing on the work station 110. In most operating systems that operate in a windowed format, each window 140 that a user opens has a window title that reflects the application or contents of the application associated with the window 140. In one embodiment, any new or changed window titles are recorded by the SAA 122 in its internal memory or event log file 132. In one embodiment, for example, the SAA polls all windows open on the workstation every five (5) seconds. The SAA 122 then compares with the last entry in the window memory or change event log file 132. In one embodiment, the titles of the changed or newly opened windows 140 are recorded. In another embodiment, the titles for the windows 140 that are no longer open are recorded too. For example, the window change event log file 132 in this embodiment has separate fields to record, newly open windows 140, changed titles, and closed windows.

As is typical in most work places today, workstations 122 may be connected into a local area network 150. In one embodiment, one of the nodes connected to the network 150 comprises a central computer or server 160. The server typically stores files and applications for use by all nodes connected to the network 150, including work stations 110. The server 160 also has a storage device 162 for storing the shared files and applications. In one embodiment, the server 160 has a memory 170 that in which a session audit services application (SAS) 172 executes. The SAS 172 comprises a set of executable instructions that operates to manage data collected by the SAAs 122 located in the network 150. In one embodiment, the data from the SAAs 122 are collected from the work stations 110 by means of SAAs 122 pushing the data to SAS 172 by using TCP/IP communication protocols.

Once such window change data is collected from each workstation 110, the SAS 172 pushes the data to a session audit web services system (SAWS) 192 (described below) through web services in XML data format. If the communication between SAS 172 and SAWS 192 can't be established (Network, Internet or SAWS 192 is down), SAS 172 will store the window change data in a network session audit log 164 on its storage device 164 for persistency. In one embodiment, the network session audit log contains the same fields as the window change event log files 132 stored on the workstations, except a fields are added to each record that identify user and workstation from which the window change data is collected. For example, if user “sally” is logged into workstation “station1,” the SAA 122 executing on “station1” polls the changes in window titles and collects the window change data and send to SAS 172. The SAS 172 stores the window change data, including the user ID, “sally,” and workstation ID, “station1,” in the network session audit log 164 for all the records that are recorded during the session that “sally” is logged into the workstation 110.

One embodiment includes a session audit web services system (SAWS) 192. In one embodiment, the SAWS 192 comprises a set of executable instructions running in the memory 190 of a web server 180. However, as with any of the components of the system, the SAWS can be collocated with any of the other components, including it on the local area network server 160. In the embodiment of FIG. 1, the SAWS 192 is located on a traditional web server 180. Further, explained below, the SAWS 192 has the ability to provide session audit web services to several different companies or several different locations of one or more companies. By using the SAWS 192 as a web service, the SAWS 192 can be hosted by a web service provider, or in-house at a company, for access by a session audit manager (described below) from anywhere in the World.

Just as the SAS 172 collects the window change data from its local network 150, the SAWS 192 collects information from one or several SASs 172 over a wide are network such as the Internet 10. In one embodiment, as with the case with the SASs 172, which collect the window change data in real time from each of the SAAs 122, the SAWS 192 collects the windows change data in real time from each of the SASs 172, and stores it in an audit services web database 184 stored in a web server storage device 182. In one embodiment, a structured queried language (SQL) is provided to make SQL calls to the web database 184.

The SAWS 192 adds each record of the audit services web database 184 to store an identifier for the SAS 172 from which it was collected, or Location ID. The audit services web database 184 is able to be organized by Location ID in order to provide management of the system by Location ID. In this regard, in one embodiment, the SAWS 194 uses the SQL server 184 to provide the extended mark-up language (XML) data needed for SAM 200 to create a real-time presentation of the window change data from the audit services web database 184.

In one embodiment, a session audit manager (SAM) 200 is used to view and manipulate and analyze the window change data from the SAWS 194. In the embodiment of FIG. 1, the SAM 200 comprises an executable set of instructions that executes from the memory 120 of a remote work station 50, or from the memory 120 of a workstation 110 connected to the local area network server 160. In one embodiment the SAM 200 is a thick client (a Window application) that reads the XML data that is created by the SAWS 194 over the Internet 10. In another embodiment, the SAM 200 comprises a thick client that interfaces with the SAWS 194 in order to provide a presentation of the windows change data. A thick client has the added ability to perform complex calculations on the data. For example, in one embodiment the SAM 200 adds the total time spent by each user running Browser Application like INTERNET EXPLORER® verses their total time logged in to the workstation 110, and compares each user's percentage of use to the average over time of other users of the Internet or other applications. For users who have a primary job that does not include the need to use the Internet excessively, an office manager using the SAM 200 can determine if a user has been using the Internet 10 excessively.

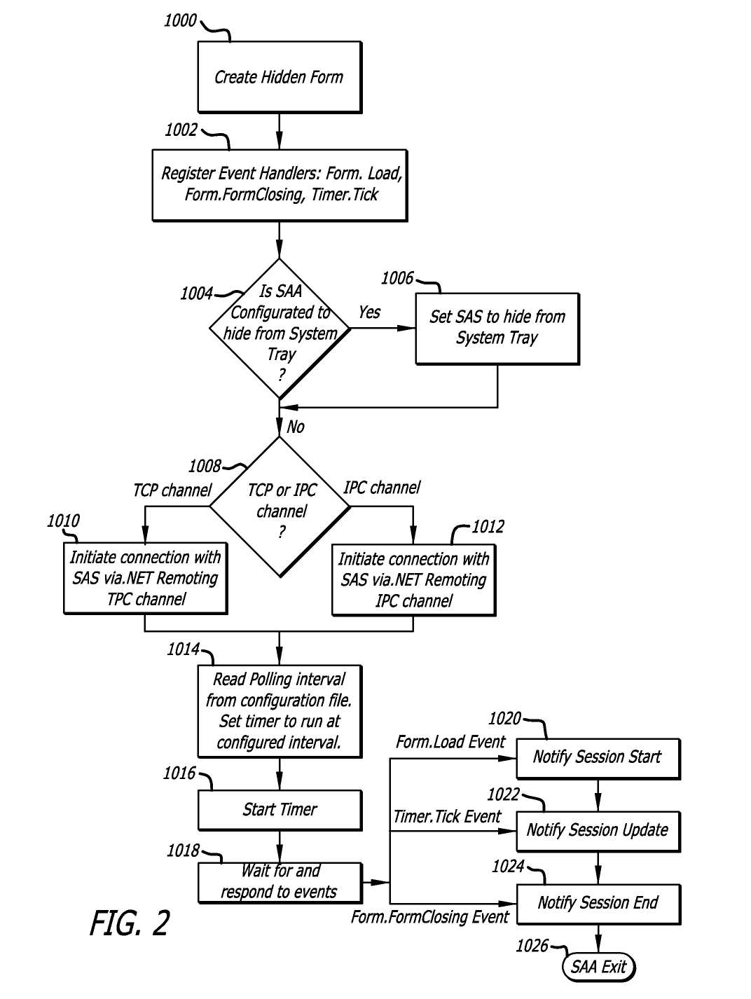

With reference to FIG. 2, a flow diagram illustrating steps performed by the SAA 122 is shown according to one embodiment. In step 1000, the SAA 122 initializes its winform. Because the SAA 122 does not need to have any user interaction with the user, therefore, it will be configured to have invisible form and not appear in taskbar to take up desktop space.

In step 1002, the SAA 122 that is installed to run at operating system start up will subscribe to the following events. The Form.Load event, which occurs during SAA's mainform initialization, signifies a user session starts. An internal timer that initiates an event with a configured interval will be used to trigger SAA 122 to send data to SAS 172 periodically. The Form.Closing event signifies a user session ends. SAA 122 provides event handlers to these events to send data to SAS 172 at various logical points.

In step 1004, the SAA 122 determines whether it should run in “stealth mode.” By default, the SAA 122 appears in the system tray. Some managers might prefer to run SAA 122 in a more stealth mode and do not want users to notice it. Stealth mode can be configured via the SAA configuration file or as a command argument.

In step 1006, the SAA 122 is set to not appear in system tray. Whether to let SAA 122 run in the system tray does not affect any of the logging, it just lets users see that SAA 122 is running for and monitoring the session.

In step 1008, the SAA 122 determines whether it should use TCP or IPC channel to communicate with SAS 172. This option is configured in the SAA configuration file. Both channels can be used for inter-process communication between the SAA 122 and SAS 172. However, an IPC channel is more efficient but is limited to inter process communication within the same machine. It's useful for installation where both SAA 122 and SAS 172 will be running on the same machine such as in a terminal server environment.

In step 1010, the SAA 122 initiates a TCP connection with SAS 172. In step 1012, the SAA 122 initiates an IPC connection with SAS 172.

In step 1014, the frequency of update sent from SAA 122 to SAS can be controlled via the PollingIntervalInMilliseconds configuration setting in SAA configuration file. The internal timer's frequency of tick event will be set to this configured value. At each tick event, the SAA 122 will send an update to SAS 172 to notify the state of the session at that point.

In step 1016, the SAA 122 starts the internal timer that triggers update calls to SAS 172. In step 1018, the SAA 122 waits for any events to respond to. In one embodiment, the SAA 122 is event driven and works by responding to various events.

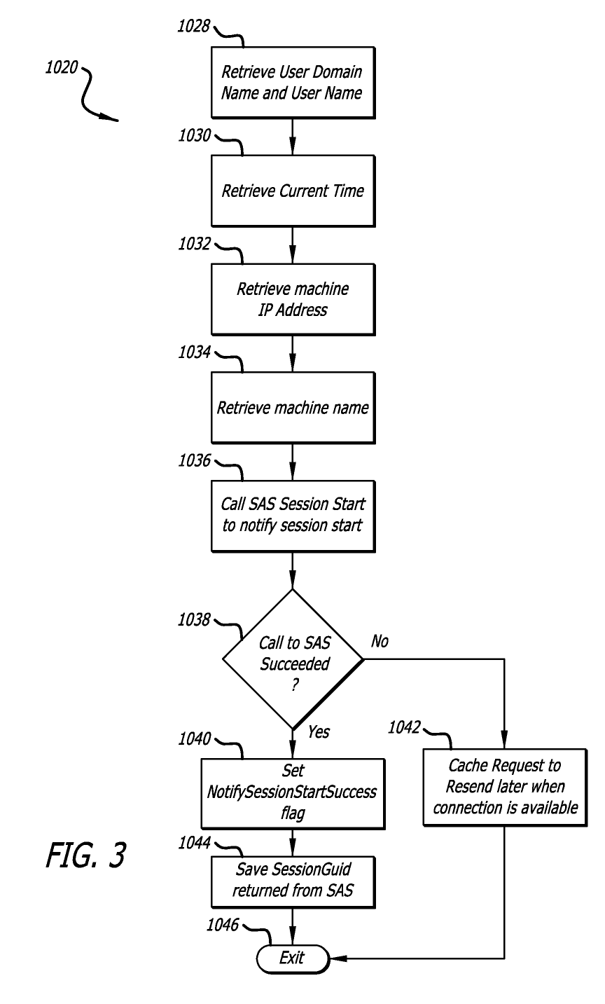

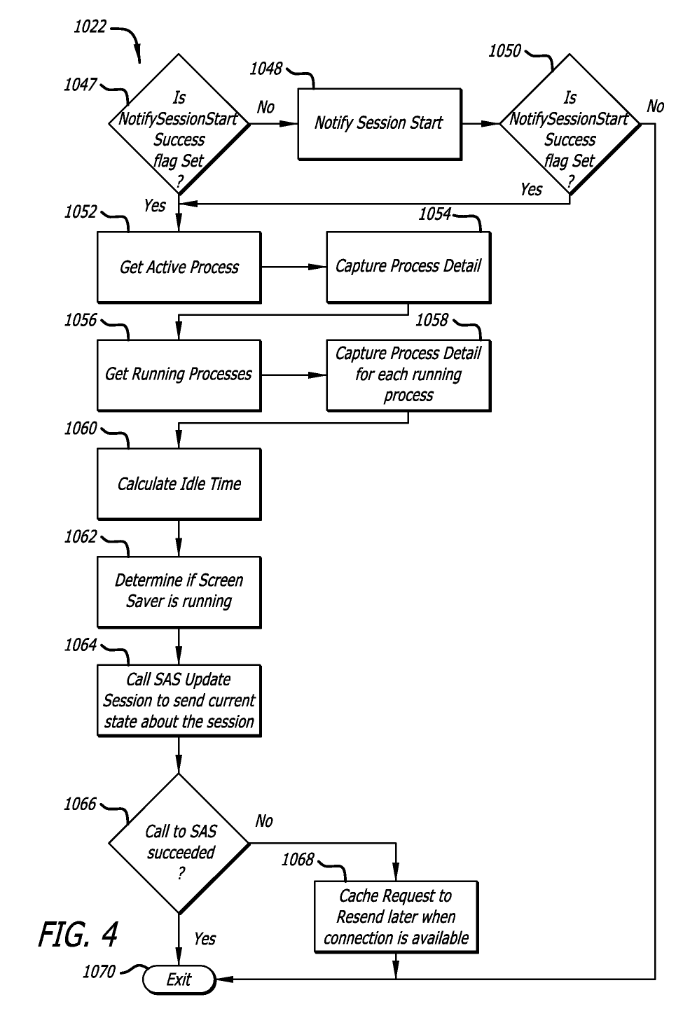

In step 1020, when a Form.Load event occurs, the SAA it will send session start data to the SAS 172 (See FIG. 3 for detailed steps). In step 1022, when a Timer.Tick event occurs, the SAA 172 will send a session update data to the SAS 172. (See FIG. 4 for detail).

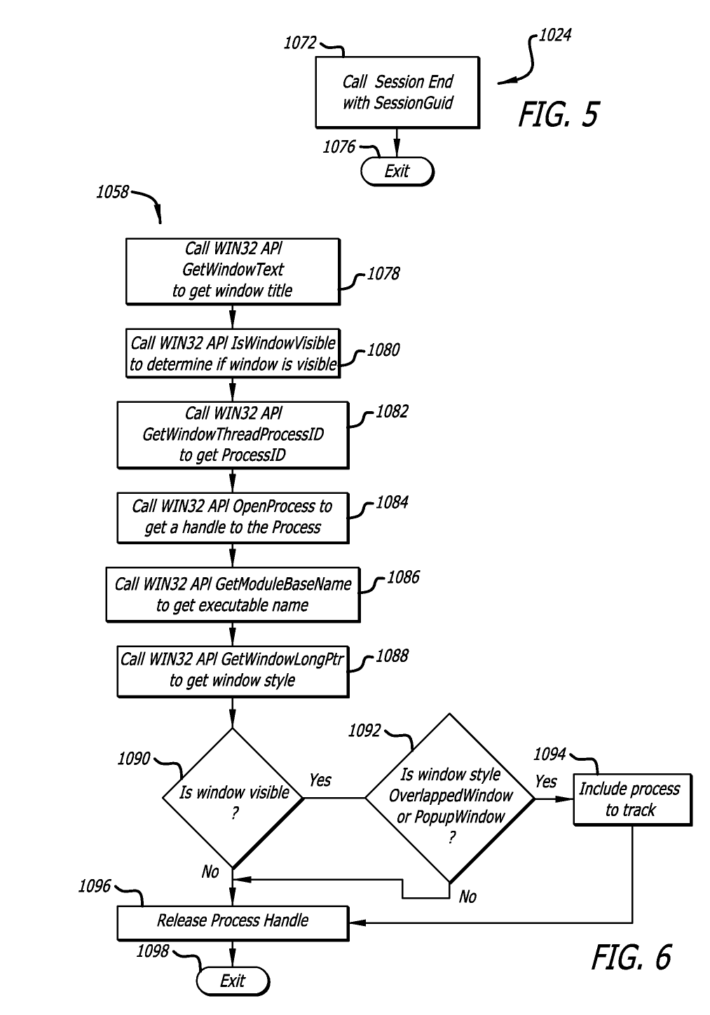

In step 1024, when a Form.FormClosing event occurs, the SAA 122 will send session end data to SAS. (See FIG. 5 for detail).

With reference to FIG. 3, a data flow diagram describes steps performed by the SAA 122 to notify the SAS 172 when a user session starts. In step 1028, the SAA 122 retrieves the logged on user's windows domain name and user name. This is how the system associates a user session to a user. In step 1030, the SAA 122 determines the current timestamp. The timestamp is used to know when this data is captured. In step 1032, the SAA 122 retrieves the IP Address. In step 1034 the SAA 122 retrieves the machine name.

In step 1036, the SAA 122 initiates a call to SAS 172 via .NET remote calling to send data and notify a user session has been started. In step 1038, the SAS 122 makes a decision on whether the call to SAS 122 was successful. In step 1040, the SAA 122 sets a flag, NotifySessionStartSuccess, in memory to signify that it had successfully contacted SAS 172 to notify user session start. The flag will be used to determine whether Session Start needs to be resent to SAS 172 before any session update data can be sent.

In step 1042, if the call to SAS 172 failed, the SAA 122 caches the data and resends later when connection is available. In step 1044, the SAA 122 saves the session global unique identifier (GUID) returned from the SAS 172. The current user session will be identified by this Session GUID from this point on. In step 1046, the SAA 122 finishes the notify session start.

FIG. 4 is a flow diagram that describes the steps performed by the SAA 122 to send updates to the SAS 172 about current user session. In step 1047, the SAA 122 checks for whether it has successfully notified SAS 172 about the current user session by checking the NotifySessionStartSuccess flag in memory. In step 1048, if it had not successfully notified Session Start, the SAA 122 tries to notify the session start to the SAS 172. (See FIG. 3). In step 1050, the SAA 122 checks NotifySessionStartFlag to determine whether last call to notify session start is successful. If successful, it will continue to send session update data to SAS, the subroutine exits.

In step 1052, the SAA 122 gets the active process in the current user session. It determines the active process by getting the process that currently has a window in focus. In step 1054, the SAA 122 captures detail information about the active process. (See FIG. 6 for detail).

In step 1056 the SAA 122 gets a list of running processes by enumerating all top level windows using WinEnum API. In step 1058, the SAA 122 captures detail information about each running process. (See FIG. 6 for detail).

In step 1060, the SAA 122 calculates the idle time. Idle time is the time duration from current time to the last time a keyboard of mouse input is detected. This is determined by using the Win32 api GetLastInputInfo. In step 1062, the SAA 122 determines whether a screen saver is running. This is determined by using Win32 API SystemParametersInfo. Screen saver is one of the 3 statuses (Active, Idle, Screen Saver) a user session can have. In step 1064, the SAA 122 sends data to the SAS 172 to update SAS's data about this user session. In step 1066, the SAA 122 decisions on whether the call to SAS 172 was successful. In step 1068, if the call to SAS 172 failed, the SAA 122 caches the data and resends it later when connection is available. In step 1070, the Notify Session update completes.

FIG. 5 is a flow diagram that describes the steps performed by the SAA 122 to notify the SAS 172 that a user session ends. In step 1072, the SAA sends data to SAS 172 to notify user session ends. In step 1076 the notify session ends.

FIG. 6 is a flow diagram that illustrates the steps performed by the SAA to capture process detail. In step 1078, the SAA calls the Win32 API GetWindowText to the window title. In step 1080, the SAA 122 calls the Win32 API IsWindowVisible to determine if window is visible. In step 1082, the SAA calls the Win32 API GetWindowThreadProcessID to get the process's ProcessID. In step 1084, the SAA 122 calls the Win32 APi Open process to acquire a handle to the process. In step 1088, the SAA 122 calls Wini32 API GetWindowLongPtr to get the styles of the process's window. In step 1090, the SAA 122 decides on whether the process's window is visible. In step 1092, the SAA 122 decides on whether the process's window style is either OverlappedWindow or PopupWindow. In step 1094, if the process window is visible, and its window style is either OverlappedWindow or PopupWindow, the SAA 122 marks it as a process that SAA 122 will track. There are other background process that the SAA 122 does not track since those are not applications that determines user activities. In step 1096, the SAA 122 releases the process handle, and in step 1098 the capturing process detail ends.

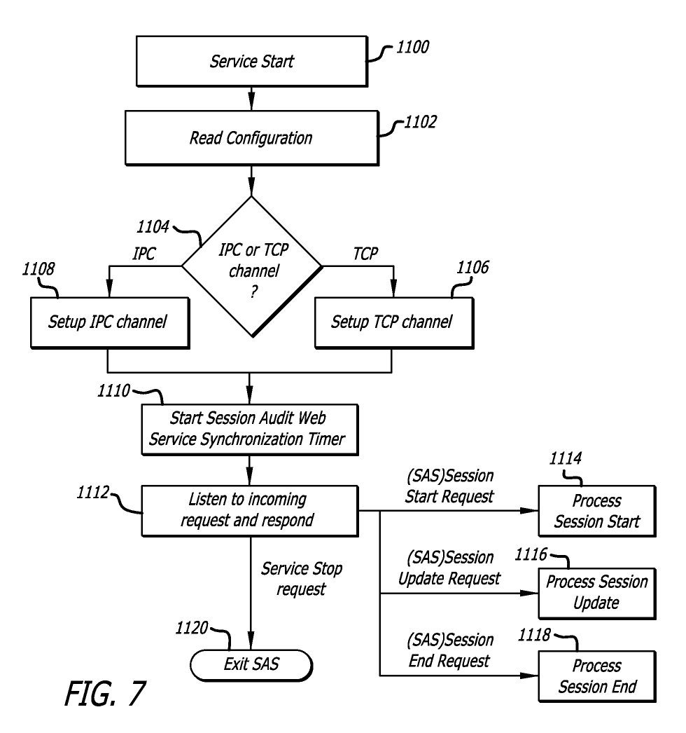

FIG. 7 is a flow diagram illustrating steps performed by the SAS 172. In step 1100, the SAS 172 starts. The SAS 172 is a windows service and can be started and stopped via the Windows SCM (Service control manager). In step 1102, the SAS 172 reads the configuration from an SAS configuration file. In step 1104, the SAS 172 makes a decision on whether SAA 122 to SAS 172 communication is using TCP or IPC channel. This option is configured in the SAS configuration file. In step 1106, if configured to use TCP connection, the SAS 172 sets up a TCP channel. The properties of the TCP channel (e.g. IP Address and port) can be configured via an SAS configuration file. In step 1108, if configured to use the IPC connection, the SAS 172 sets up an IPC channel. The properties of the IPC channel (e.g. name of end point) can be configured via the SAS configuration file. In step 1110, the SAS 172 starts an internal timer. This timer is configured to fire an event. At each occurrence of the timer event, SAS 172 will send data to the SAWS 192.

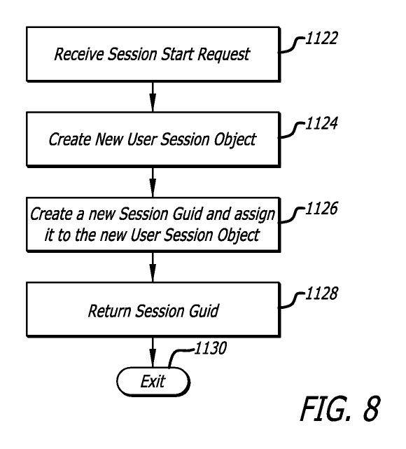

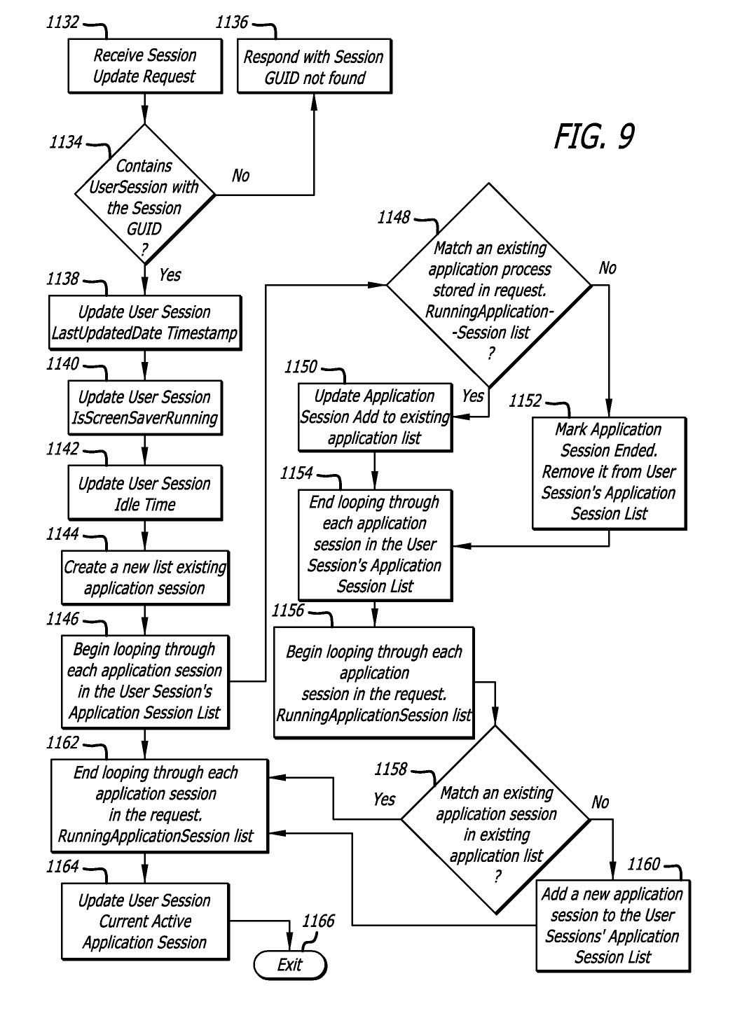

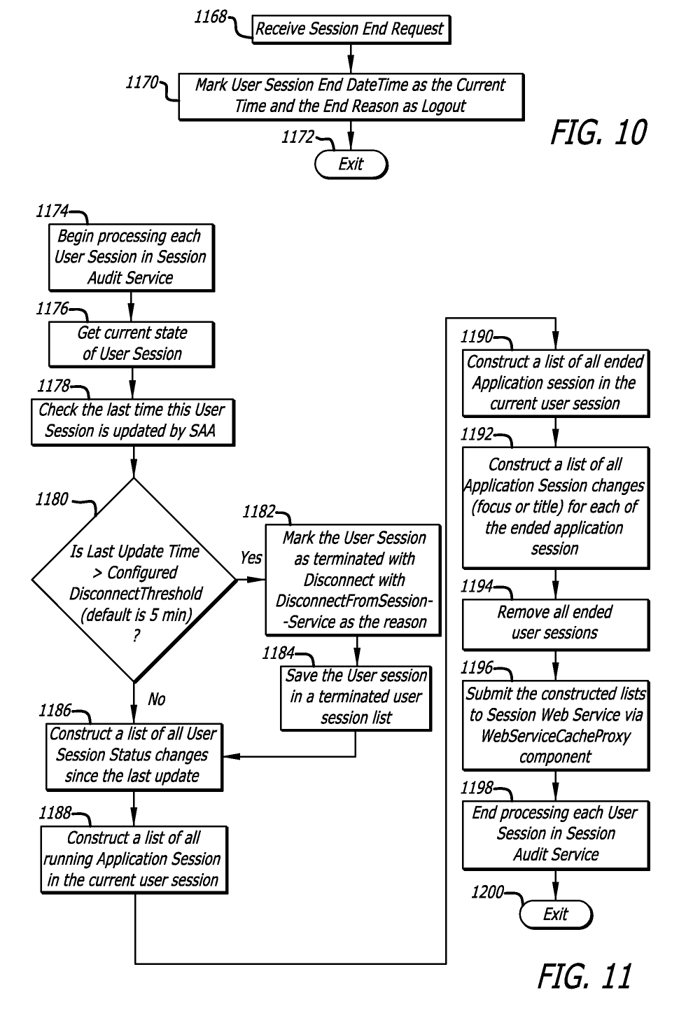

In step 1112, the SAS 172 Waits for each SAA 122 to call and send data. In step 1114, the SAS 172, for example, receives a Process Session Start call from an SAA 172. (See FIG. 8 for detail). In step 1116, a Process Session Update call from the SAA is received. (See FIG. 9 for detail). In step 1118, a Process Session End call is received from the SAA 122. See FIG. 10 for detail. In step 1120, the SAS 172 stops. The SAS 172 service is requested to stop via Windows SCM.

With reference to FIG. 8, a flow diagram describes the steps performed by the SAS 172 to process a session start request. In step 1122, a session start request is received from SAA 122. In step 1124, the SAS 172 creates a new User Session Object in memory. This is used to keep track of all data associated with this user session from this point on. In step 1126, the SAS 172 creates a new Session GUID and assigns to the user session object. This Session GUID will be used to uniquely identify this user session. In step 1128, the SAS 172 returns the Session GUID to the SAA 122. In step 1130, the SAS 172 finishes processing session start request.

FIG. 9 is a flow diagram that describes steps performed by the SAS 172 to process a session update request. In step 1132, a session update request is received from SAA 172. In step 1134, the SAS 172 looks up user sessions in memory for the Session GUID sent by SAA 122, and decides on whether a matching user session is found. In step 1136, if no matching user session is found, the SAS 172 returns a Session-GUID-not-found code to the SAA 122.

In step 1138, the SAS 172 gets the matching user session and update the timestamp of the last update. In step 1140, the SAS 172 updates whether the screen saving is running. In step 1142, the SAS 172 updates the idle time. In step 1144, the SAS 172 creates a temporary list that will be used to store existing applications (Applications that were in the user session before this update). In step 1146, the SAS 172 begins looping through each application session stored in the matching user session. (Compare the existing application sessions in the user session to the running application session list sent by SAA 122 to determine any new, existing, and terminated application sessions). In step 1148, the SAS 172 decides on whether the application session is also found in the running application session list sent by SAA 122. In step 1150, if the application session is found in the running application session list sent by SAA 122, this means the application session was in user session and is still running. The SAS 172 adds it to the existing application list. Otherwise, in step 1152 the application is in the user session list but not in running application session list, meaning it has terminated. The SAS 172 marks the application session as ended. In step 1154 the loop terminates.

In step 1156, the SAS 172 begins looping through each application session in the request application session list. In step 1158 the SAS 172 makes a decision on whether the application session match any application session in the existing application session list. If no match is found, that means this is a new application session previously not existed in this user session. In step 1160, the SAS 172 adds application session to the user session's application session list. In step 1162, the SAS 172 finishes the loop.

In step 1164, the SAS 172 updates the user session's current active application. In step 1166, the SAS 172 finishes processing the session update request.

FIG. 10 is a flow diagram that illustrates the steps performed by the SAS 172 to process a session end request. In step 1168, the SAS 172 receives a session end request from SAA 122. In step 1170, the SAS 172 marks the user session as ended, and updates the user session end reason as logout. In step 1172 the SAS 172 finishes processing session end request

FIG. 11 is a flow diagram that illustrates the steps performed by the SAS 172 to synchronize user session data with the SAWS 192. This process occurs periodically at configured intervals to synchronize user session data with SAWS 192. In step 1174, the SAS 172 begins looping through each user session stored in memory. In step 1176, the SAS 172 determines the current status of the user session. In step 1178 the SAS 172 checks last update timestamp, which is updated every time the SAA 122 sends an update to the SAS 172, and determines the time elapsed since the last update. In step 1180, the SAS 172 decides on whether the configured DisconnectThreshold variable has been past since the last update. When a user session has been not updated over a configured amount of time by SAA 122, that means the session is ended unexpectedly, such as by a power shut down, or if the network connection between SAA 122 and SAS 172 is down. This time period is compared to the DisconnectThreshold variable. In step 1182, if the time period has exceeded the configured DisconnectThreshold, the SAS 172 marks the user session as terminated with reason set to “DisconnectFromSessionService.” In step 1184, the SAS 172 saves the user session in the terminated user session list.

In step 1186, the SAS 172 constructs a list of user session status changes. These changes mark the beginning and end whenever a user's status changes. User status can either be Active, Idle or Screen Saver. In step 1188, the SAS 172 constructs a list of all running application sessions in the user session. In step 1190, the SAS 172 constructs a list of all ended application sessions in the user session. In step 1192, the SAS 172 constructs a list of application session changes which include either title or focus changes. In step 1194, the SAS 172, the SAS 172 removes all ended user sessions from SAS 172 memory.

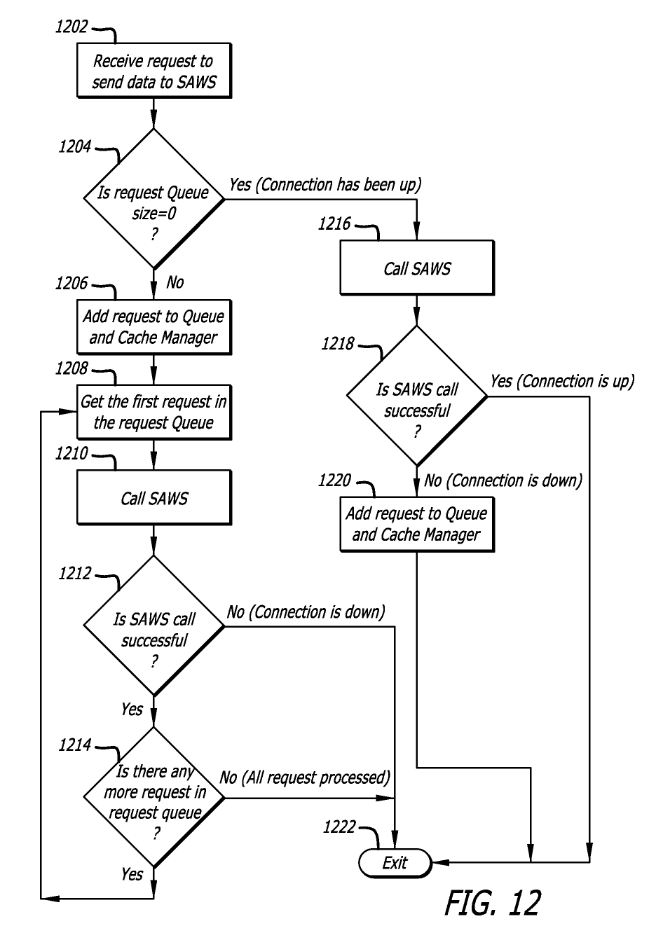

In step 1196, the SAS 172 sends the data to the SAWS 192 via a WebServiceCacheProxy component. (See FIG. 12). In step 1198, the loop terminates. In step 1200, the SAS 172 finishes one cycle of synchronizing user session data.

FIG. 12 is a flow diagram that illustrates the steps performed by the SAS 172 to send data to SAWS 192. The flow includes logic to cache data if the SAWS 192 or connection between SAS 172 and SAWS 192 is down. In step 1202, a request is received to send data to the SAWS 192. In step 1204, the request queue size is checked. The request queue stores any outstanding send data request. It will normally be 0. But if there are requests that failed previously, the size will be greater than 0. In step 1206, if the queue size is greater than 0, that indicates one or more previous fail requests. The SAS 172 adds the request to the queue and to a cache manager (provides persistent manager in case SAS is shutdown, data will be preserved). In step 1208, the SAS 172 gets the first item in the request queue. First-in-first-out (FIFO) is used. This ensures the request that was submitted first will be sent to SAWS 192 first. In step 1210, the SAS 172 calls the SAWS 192 to send data. In step 1212 the SAS 172 decides on whether SAWS call was successful. In step 1214, if the SAWS call was successful, that means that connection is up, and processing moves to step 1208 to process other outstanding request until all requests are processed.

In step 1216, the SAS 172 calls SAWS 192, and in step 1218, determines whether the SAWS call was successful. In step 1220, if the SAWS call failed, the connection is down. The requested is added to the queue and cache manager. In step 1222, the process is finished for sending data to the SAWS 192.

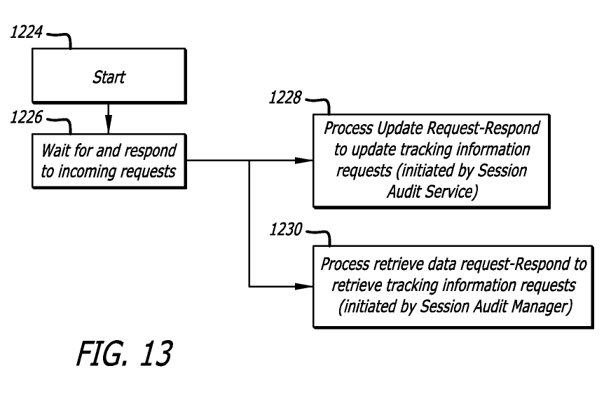

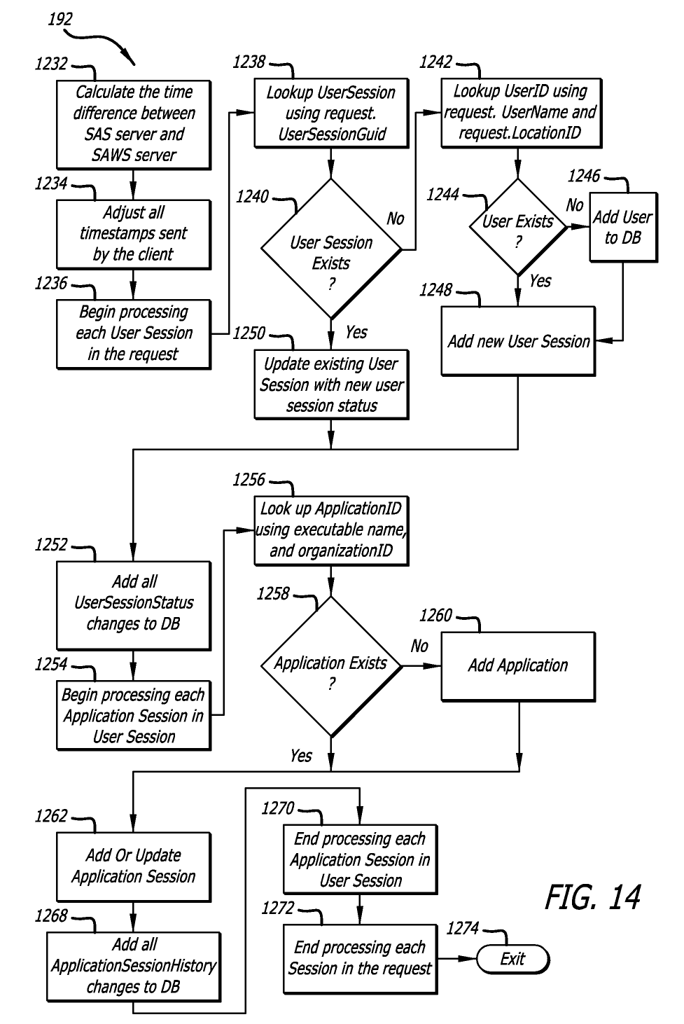

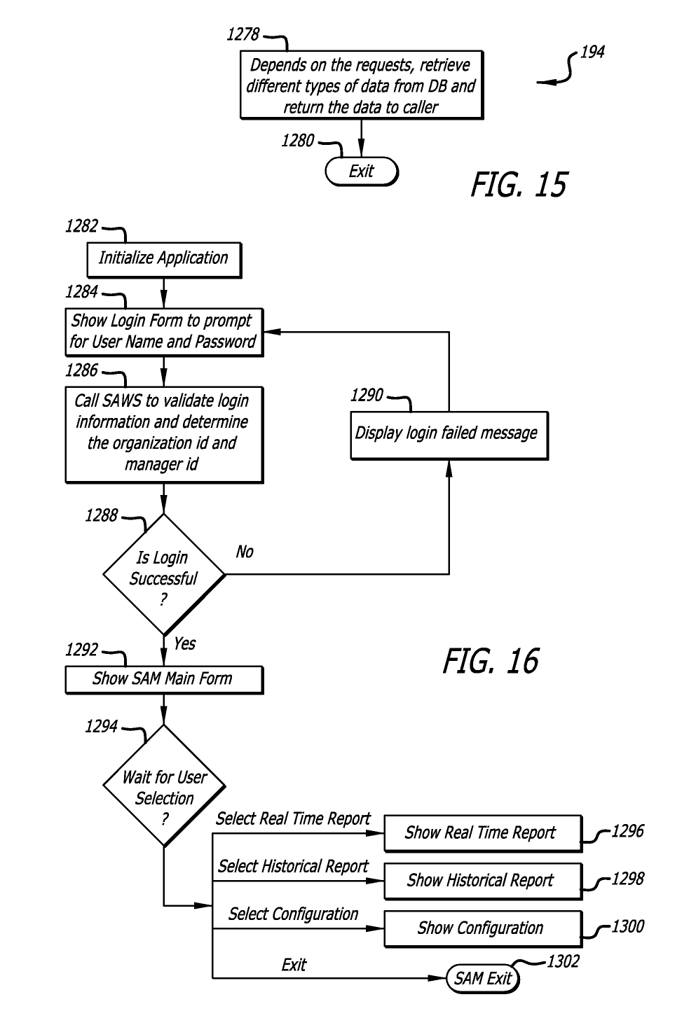

FIG. 13 is a flow diagram that describes steps performed of the SAWS. SAWS comprises two main parts: SAWS 192 and 194. In step 1224, the SAWS starts. In step 1226, the SAWS waits for any requests and responds to them. In step 192, the SAWS receives and processes a request to send tracking data (see FIG. 14). In step 194, the SAWS receives and process a request to retrieve data for the SAM 200 (see FIG. 15).

FIG. 14 is a data flow diagram that illustrates steps performed by the SAWS 192 to process update data requests. In step 1232, the SAWS 192 calculates any time difference between the caller server and the SAWS server 180. This is to prevent situations where an SAS server's 160 time is off so as to affect data accuracy. In step 1234, the SAWS 192 adjusts all timestamps sent by the caller by the calculated time difference. In step 1236, the SAWS 192 begins looping through each user session object in the request. In step 1238, the SAWS 192 looks up the user session in the database 184 using the session GUID that was sent by caller. Step 1240 is a decision on whether the user session is found in the database 184. In step 1242, if the user session is not found in database 184, the SAWS 192 looks up the user in the database using the user name and Location ID sent by the caller. In step 1244 a decision is made on whether the user is found in the database 184. In step 1246, if the user is not found in the database 194, then the SAWS 192 adds the new user. In step 1248, the SAWS 192 adds the new user session to the database 184.

In step 1250, if the user session is found in the database, the user session is added to the database 184. In step 1252, the SAWS 192 adds all user session status changes to the database 184. In step 1254, the SAWS 192 begins looping through each application session in the user session object. In step 1256, the SAWS 192, looks up the application using executable name and organization ID. In step 1258, the SAWS 192 makes a decision on whether application is found in the database 184. In step 1260, if the application is not found, the SAWS 192 adds it to the database 184. In step 1262, the SAWS 192 adds or updates the application session to the database 184. In step 1268, the SAWS 192 adds all application session changes (focus or title) to the database 184. In step 1270, the SAWS 192 finishes looping through each application session in the user session. In step 1272, the SAWS 192 finishes looping through each user session in the request. In step 1274, the SAWS 192 finishes processing the data update request.

FIG. 15 is a data flow diagram that illustrates the steps performed by the SAWS 192 to allow the SAM 200 to retrieve data from the centralized database 184. In step 1278, depending on the data requested, a call is made to one or more stored procedures to retrieve the data from the database 184 to return data to the caller. In step 1280, processing the retrieve data request completes.

FIG. 16 illustrates the steps performed by the SAM 200 according to one embodiment and procedure. In step 1282, the application is initialized. In step 1284, a login form is displayed to prompt for user name and password for the SAM 200. Because the database can contain data for more than one company and the data is sensitive, in one embodiment, the SAM 200 will always validate the user before he/she can login to SAM 200. In step 1286, a call is made to the SAWS 192 to validate the user name and password and determine the organization ID and manager ID. The organization and manager ID will be used later to identify the objects that the manager has permission on. In step 1288, the system makes a decision on whether the user name and password is correct. In step 1290, if the login failed, the SAM displays an error message and processing moves to step 1284 to allow the user to re-enter username and password.

In step 1292, the SAM main form is displayed. The SAM 200 main form is the main user interface (UI), and provides UIs to navigate into other parts of the SAM 200. In step 1294, the SAM 200 is an event driven windows application that will wait for user selection and respond to the events. In step 1296, a real time report button is clicked, and the SAM 200 responds by showing all the real time reports available. In step 1297, a historical report button is clicked, to which the SAM 200 responds by showing all the historical reports available.

In step 1300, configuration setting changes are requested, to which the SAM 200 responds by showing the UI to change configuration information. In step 1302, an end application is requested, to which the SAM 200 responds by terminating the application.

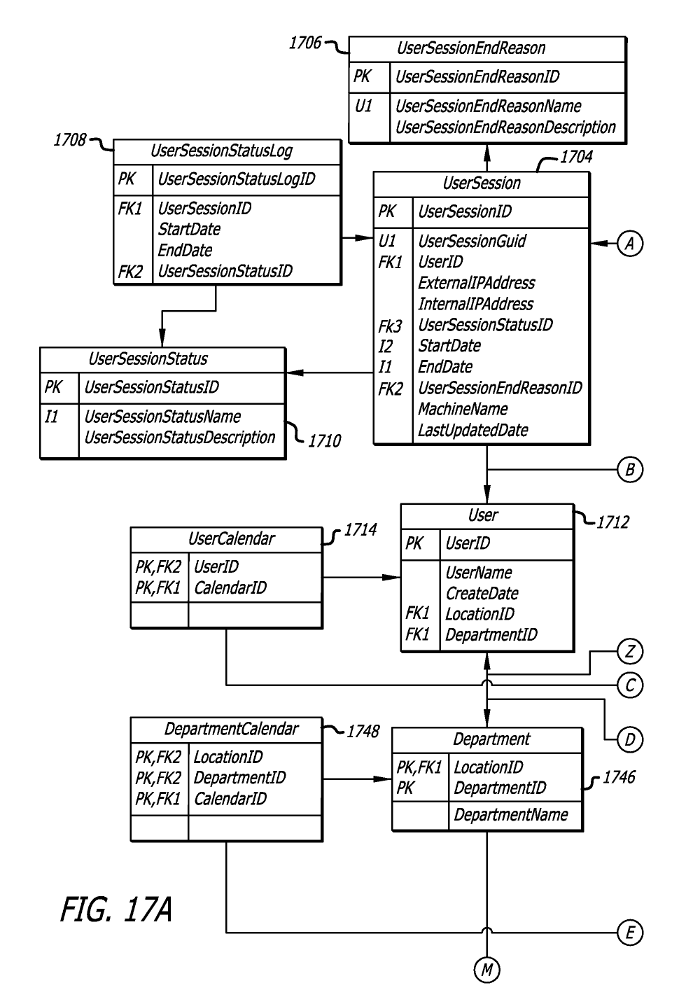

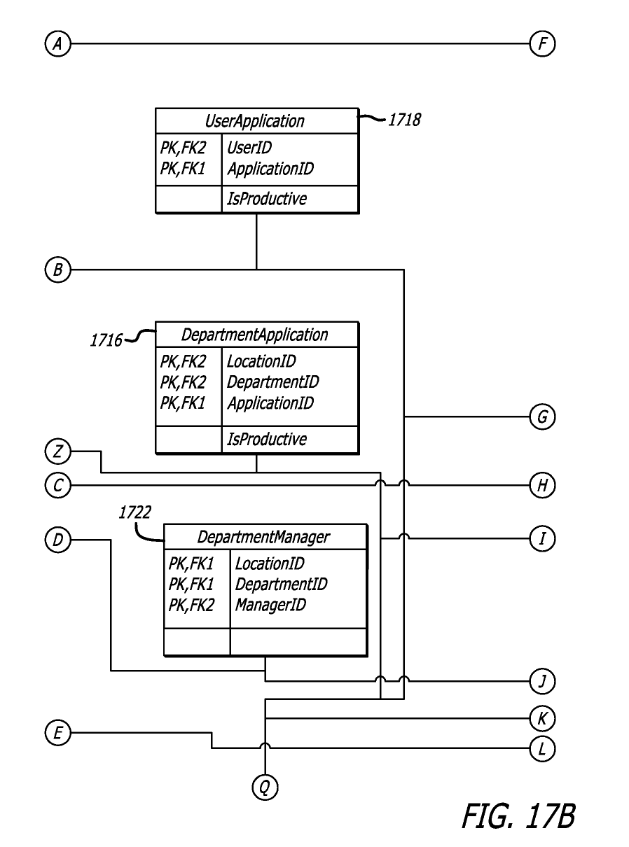

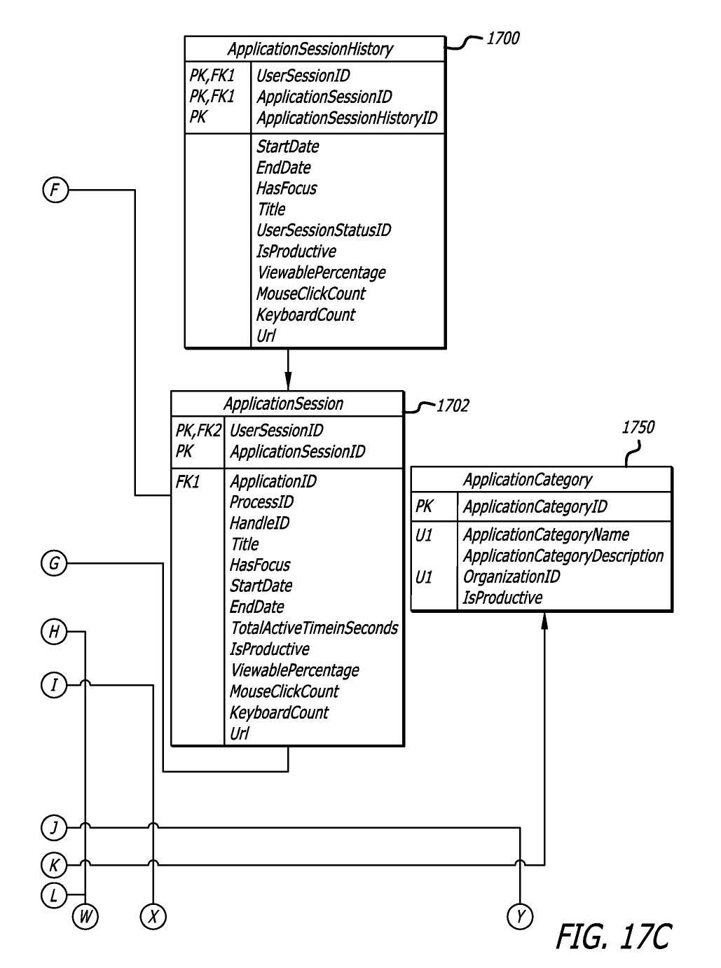

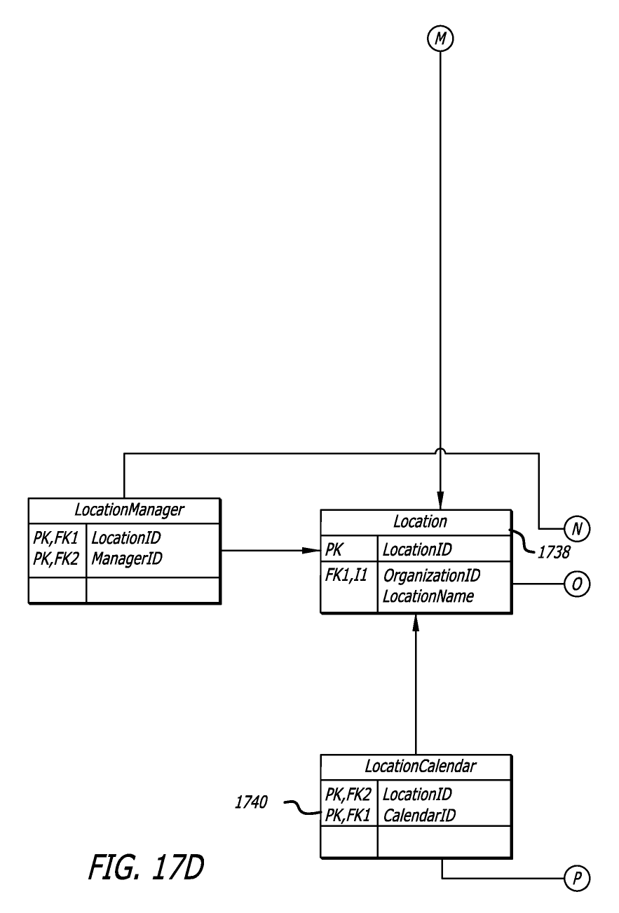

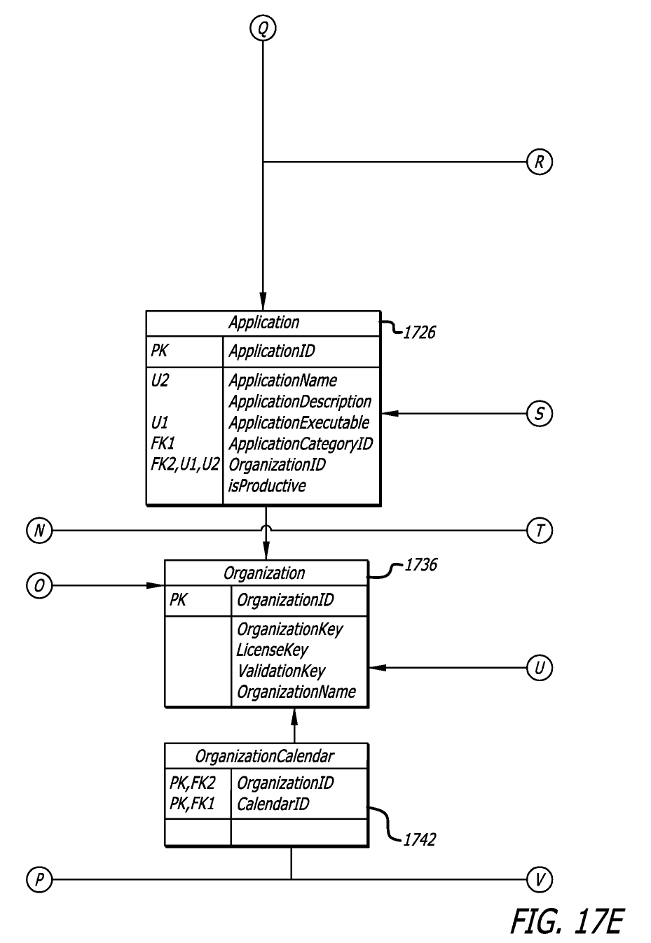

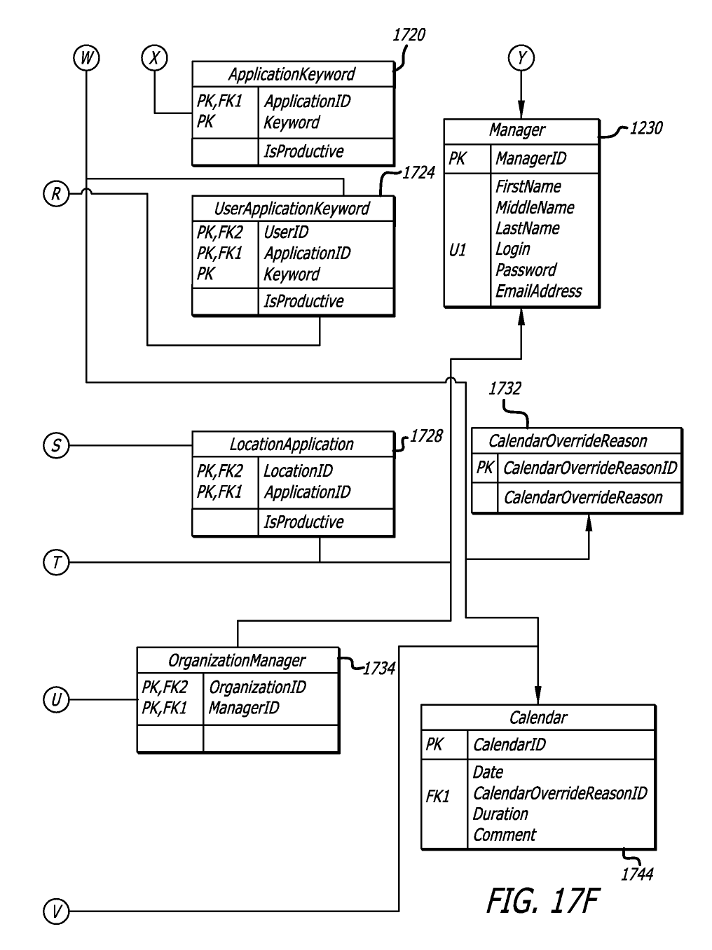

FIG. 17 presents a database schema according to one embodiment. In step 1700, an ApplicationSessionHistory table stores information about terminated application sessions. It mirrors the ApplicationSessionHistory table which stores active Application sessions. Start date indicates the start date of the application session. End date indicates the end date of the application session. HasFocus indicates whether the application session has focus during the period between StartDate and EndDate. Title indicates the window title. The UserSessionStatusID indicates the UserSessionStatus in the duration specified by the StartDate and EndDate. IsProductive indicates whether this application is considered productive. ViewablePercentage indicates the viewable percentage of this application's window area compare to the desktop's total available area. This can generate report to identify user that tries to “cheat the system” by displaying more than 1 application side by side, setting the focus on a productive application while viewing on another application that has a large viewable percentage.

MouseClickCount indicates the total number of mouse clicks in the duration specified by StartDate and EndDate. KeyboardCount indicates the total number of keystrokes in the duration specified by StartDate and EndDate. URL indicates the Uniform Resource Locator if the application is a browser.

Table 1702 is the ApplicationSession table that stores information about running application session. When an application session is ended, it will be moved into the ApplicationSessionHistory table. The column in this table mirrors the ones in ApplicationSessionHistory table.

Table 1704 is the UserSession that stores information about a user session. The UserSessionID is the database key for a user session record. The UserSessionGuid field is a GUID (global unique identifier) that uniquely identifies this user session. This value is not generated in the database. It's generated in SAS 172 as described above, and is sent over to SAWS 192 and stored in the database 184. UserID identifies the user whom this user session is for. ExternalIPAddress identifies the external IP Address of the machine the user session is running on. InternalIPAddress identifies the internal IP Address of the machine the user session is running on. In most situations, the ExternalIPAddress will identify the organization firewall or router and the InternalIPAddress identifies the computer on the network inside the firewall or router. UserSessionStatusID identifies the current user session status. StartDate indicates the start date and time of the user session. EndDate indicates the end date time of the user session. UserSessionEndReason indicates the reason the user session is ended if it is ended. Machine name indicates the machine name of the machine the user session is running on.

LastUpdatedDate indicates the last time the user session is updated. This can be used to detect when a connection between SAS 172 to SAWS 192 is broken. Moreover, there is a backend stored procedure that queries all user session records that have not been ended but are not updated in the last 15 minutes. This indicates whether there is some problem between SAS 172 and SAWS 192. This process will update these user session to mark them as ended with the value DisconnectionFromSAWS as the end reason.

Table 1706, UserSessionEndReason, is a lookup table. The values are listed in the table below

| UserSessionEndReasonID | userSessionEndReasonName |
|---|---|
| 5 | AutoLogout |
| 4 | DisconnectedFromSessionService |
| 3 | DisconnectedFromSessionWebService |
| 2 | Logout |
| 1 | Unknown |

Table 1708, UserSessionStatusLog, stores status changes of a user session. UserSessionStatusLogID is a database key for this record. UserSessionID indicates the user session this status change is for. StartDate indicates the start date time. EndDate indicates the end date time. UserSessionStatusID indicates the status in the duration specified by the StartDate and EndDate. Table 1710, UserSessionStatus, is a lookup table. The values are below

| UserSessionStatusID | UserSessionStatusName |
|---|---|
| 2 | Active |
| 1 | Idle |
| 3 | Screen Saver |

Table 1712, User table, stores the user information. UserID is the database key. UserName is the name of the user. CreateDate is the date time the user was created. LocationID indicates the location this user belongs to. DepartmentID indicates the department this user belongs to.

Table 1714, UserCalendar, is a linking table between a User record and a calendar record. A record stored in this table indicates an override of a calendar at the user level. UserID indicates the user this record links to. CaldendarID indicates the calendar this record links to

Table 1716, DepartmentApplication, stores application information specific to a department. It's used to override the IsProductive attribute of an application by a department. (i.e an organization can classify IE as non-productive, but the R&D department can override it and classify it as productive by setting a flag at the department level). LocationID links this record to the location. DepartmentID links this record to the department. ApplicationID links this record to the application. IsProductive indicates whether this application is productive for this department.

Table 1718, UserApplication, stores application information specific to a user. Similar to DeaprtmentApplication that allows override of application information on a department level, UserApplication allows override application information on a user level.

Table 1720, ApplicationKeyWord, stores a list of keywords that affect how an application will be classified as productive or non-productive. Before the SAWS 172 stores an application session into the database, it will check the window title against the key application word list, the IsProductive attribute will be taken from the ApplicationKeyWord record if a match is found and assign to the application session. ApplicationID indicates the application this record is for. Keyword indicates the keyword that should be matched. IsProductive indicates whether the keyword for the application should be classified as productive.

Table 1722, DepartmentManager, is a linking table between department and manager. It specifies the department a manager has permission to the objects for. LocationID links to the location table. DepartmentID links to the department table. ManagerID links to the manager table. Table 1724, UserApplicationKeyWord, stores a list of keywords that affect how an application will be classified as productive or non-productive for a particular user. It works the same way as ApplicationKeyWord (table 1720), but this list only applies to a particular user

Table 1726, Application table, stores information about an application. ApplicationID is the database key. ApplicationName is the name of the application. ApplicationDescription indicates the description. This field will not be populated if an application is dynamically added by the SAWS 192. This is more for reporting purpose and can be populated in advance for popular applications or can be updated later after applications are added by SAWS 192.

ApplicationExecuable indicates the name of the executable

ApplicationCategoryID indicates the application category for this application. This field will not be populated by SAWS automatically, but can be updated later. See ApplicationCategory 1750 for more detail.

OrganizationID indicates the organization this application is added for IsProductive indicates whether this application should be classified as productive

Table 1728, LocationApplication, stores information specific to a location. Similar to 1716 DepartmentLocation that allows override application information on a department level, LocationApplication allows override application information on a location level.

Table 1730, Manager, stores information about a manager. The only users that have a right to login to the SAM 200 to view reports are manager users stored in this table. MangerID is the database key. FirstName, MiddleName, LastName store the user's name information. Login indicates the login of the manager, used to login to the SAM 200. Password indicates the password of the manager, used to login to the SAM 200. EmailAdddress indicates the email address. Storing the e-mail address of the manager can be helpful in the event when the manager forget the login password.

Table 1732, CalendarOverrideReason, stores the reason of why a calendar is overridden when it is being overridden. CalendarOverrideReasonID is a database key CalendarOverrideReason is a text description of the override reason.

Table 1734, OrganizationManager, is a linking table between organization and manager. A linking record indicates the manage has permission over all objects under the linked organization. OganizationID links to an organization record. ManagerID links to a manager record.

Table 1736, Organization, stores information about an organization. OrganizationID is a database key. OrganizationKey is an identifier of the organization. LicenseKey indicates the license assigned to this organization. ValidationKey is used to store a key to validate a license. OrganizationName indicates the name of the organization.

Table 1738, Location, stores information about a location. LocationID is a database key. OrganizationID indicates the organization this location belongs to. LocationName provides a text description of the location.

Table 1740, LocationCalendar, links a location to a calendar. A LocationCalendar record indicates that the calendar is a location level calendar. (See description of table 1744 below for more detail). LocationID links to a location record. CalendarID links to a calendar record.

Table 1742, OrganizationCalendar, links an organization to a calendar. An OrganizationCalendar record indicates that the calendar is an organization level calendar. See 1744 for more detail. OrganizationID links to an organization record. CalendarID links to a calendar record.

Table 1744, Calendar, stores information about a calendar date. Calendar is used to specify the date that users are expected to work. With this information, a company can generate report to compare against the hours worked reported by users to hours users are actually in the system. It provides 4 levels of overrides to allow more control—OrganizationCalendar-→LocationCalendar-→DepartmentCalendar-→UserCalendar. Overrides occur in many situations. For example, a user is allowed to work flexible time where he/she might work 12 hours in a day and 4 in another. Also users in different locations can have different cultures and different holidays, and users in different departments can have different work hours. Specifically, an override may occur when a user takes a vacation, wherein the calendar for the vacation days should be overridden at the user level and have the duration set to 0 for those days of vacation. Comment may be added for those days. CalendarID is a database key. Date indicates the date this calendar record is specifying. CalendarOverrideReasonID links to a CalendarOverrideReason record. This will be NULL unless the calendar record is an override. (i.e. UserCalendar overriding OrganizationCalendar). Duration indicates the duration of this calendar record. This will be 8 for organization that works 8 hour day. Comment indicates comment added for this calendar record. Useful only for override situation.

Table 1746, Department, stores information about a department. LocationID indicates the location this department belongs to. DepartmentID is a database key. DepartmentName indicates the name of the department.

Table 1748, DepartmentCalendar, links a department to a calendar. A DepartmentCalendar record indicates that the calendar is a department level calendar. See description for table 1744 above for more detail. DepartmentID links to a department record. CalendarID links to a calendar record.

Table 1750, ApplicationCategory, stores categorization information for applications. Each category is a grouping of applications. It helps to manage a group of applications that has similar properties. For example, games, browsers, word processing application. ApplicationCategoryID is a database key. ApplicationCategoryName indicates the name of the category. ApplicationCategoryDescription provides text description of the category. OrganizationID indicates the organization this category is created for. IsProductive indicates whether the applications in this category should be treated as productive.

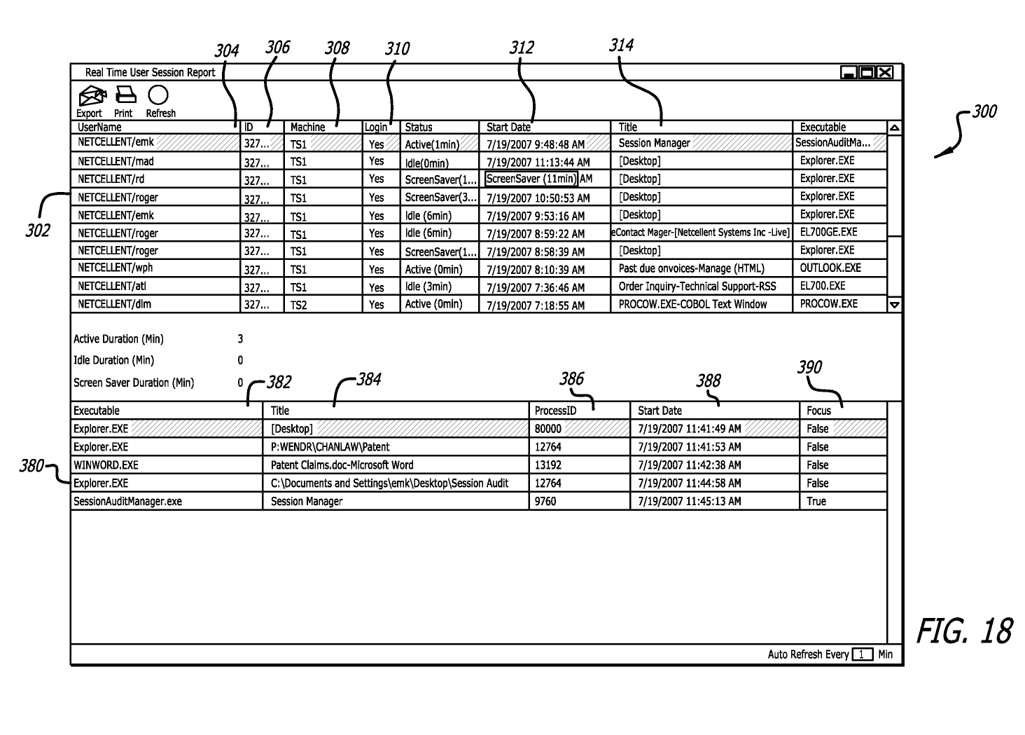

With reference to FIG. 18, an exemplary screen shot illustrates a real time view presented by SAM 200 to a manager. A manager can be defined as the manager of one or many organizations, locations or departments. In the embodiment of FIG. 18, the SAM 200 displays a window 300 in which all of the real time user sessions on a particular Organization, Location or Department base on the login Manager ID and privilege. Since a user can login multiple times on different machines, or even on the same machine, so you may see the same user show up multiple times since they may have multiple sessions. In a top window pane 302 of the window 300 is a first column having a list of users 304, allowing highlighted selection of a user session. Another column of the top window pane 302 is the session ID column 306 that displays the user session ID to uniquely identify the user session on a computer. Another column comprises a machine “ID” column 308. The Machine ID which is the NetBIOS name uniquely identifies the computer or device in a network for the record. Another column comprises a login status column 310 that indicates whether a user is logged into the computer or device. Yet another column is a “start date” column 312 that indicates the starting date and time for the user's session. Another column comprises a “title” field 314 that indicates the window title for the current focused window for the user. By looking at the top window pane 302, the manager can have an overall view of what each users are doing at the moment.

In FIG. 18, as shown, the first user is highlighted. In a bottom window pane 380 of the SAM window 300, all of the windows currently open for the highlighted user are listed. In the bottom window pane 380, an executable file column 382 contains the executable file name for each open window listed in the bottom portion 380. The window title for each open window is listed in a window name column 384. A process ID column 386 contains the operating system-assigned process ID for each application. A start date column 388 in the bottom portion 380 indicates the date and time that the window was opened. A focus status column 390 indicates whether that window is in focus. There won't be more than one window in focus at any given moment. This screen is updated in real time by means of the three tiered information transfer system described in the embodiment below. When manager highlights a particular user session, the bottom window pane will display all open windows for that user session, no matter if the window is in focus or minimized. In some situations, a user may utilize certain window applications without the need to make the window in focus. This may includes, but not limited to, Windows Media Player, News Update, or Browsing to Internet.

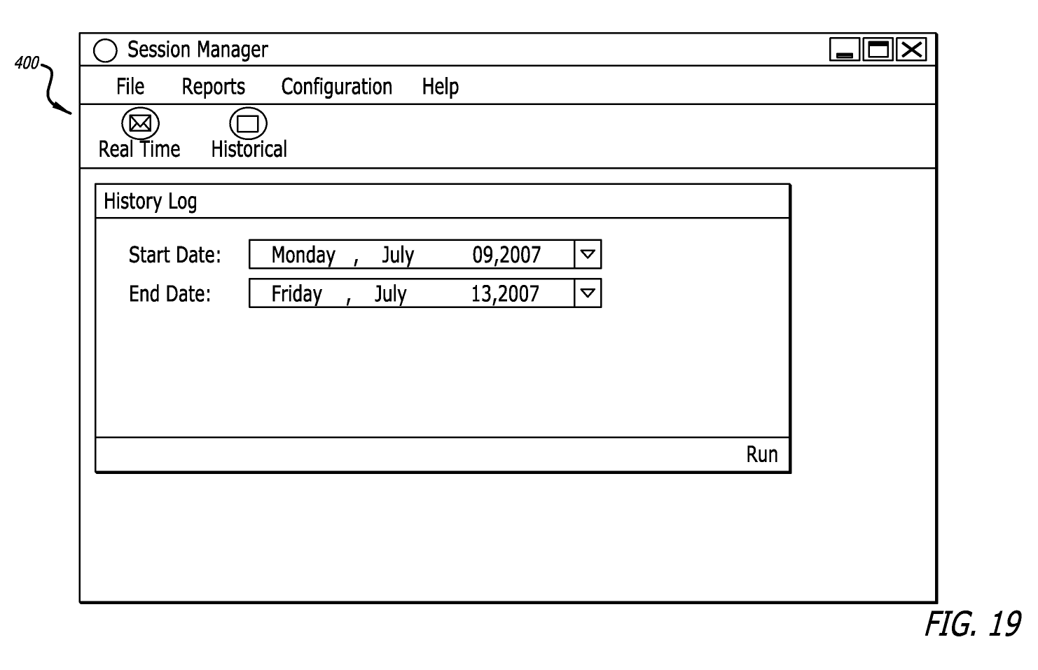

The SAM 200 offers many analysis and system usage audit tools to allow a manager to monitor and manage users of the network devices 110, and to analyse their usage. With reference to FIG. 19, a part of the SAM 200 allows for a historical view of the windows change event data for the users. The Screen 400 of FIG. 19 is presented to allow the user to select the date range for view the historical data.

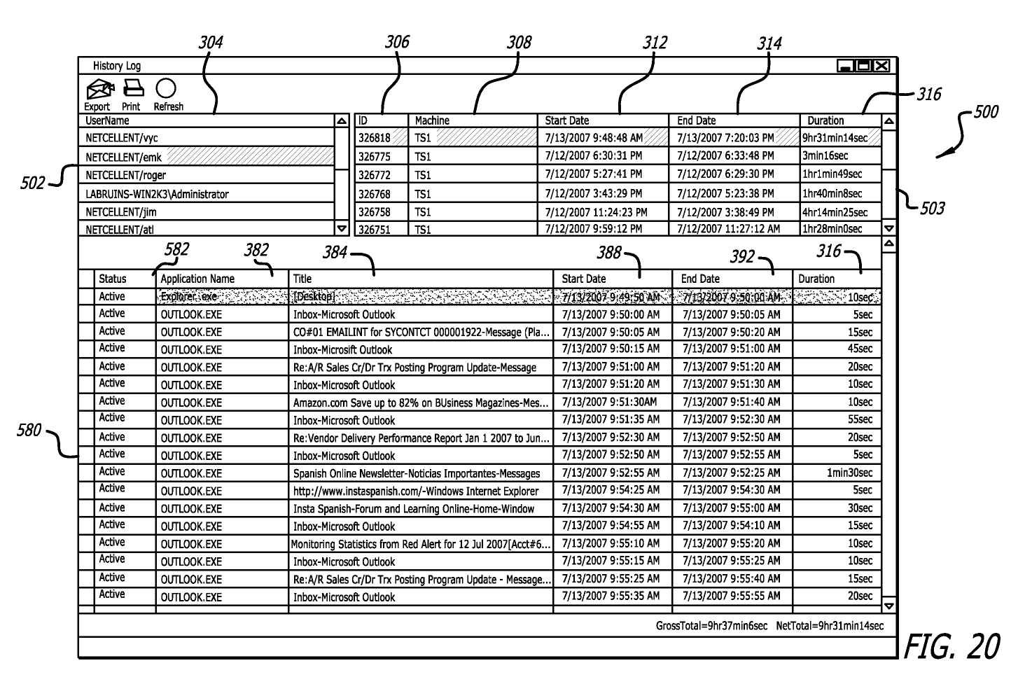

With reference to FIG. 20, a historical view screen 500 is shown base on the date range user selects in FIG. 19. This screen has similarities with the real time view screen 300 of FIG. 18, and like columns are labelled in FIG. 20 accordingly. The top portion of windows 500 is divided into two Window panes 502 and 503. Window pane 502 give user a list of users of a location to select. When a user is highlighted, that user's historical sessions, base on the date range selection, will be displayed on the Window pane 503. An “end date” field 314 provides the date that the user closed the particular session. A duration field 316 indicates the duration that the user session stays login. The bottom portion 580 of the screen 500 provides detail of the historical data of window change events for the user session highlighted in the upper portion of the window pane 503. A “status” field 582 in the bottom portion 580 indicates the status of the user's session (e.g., Active, Idle, Screen Saver) during the time indicated by the duration field 316. Active is defined as the user has either keyboard or mouse input in the last one minute. Idle is defined as the user has no keyboard or mouse input in the last one minute. Screen saver is when the screen saver is running due to extensive amount of time user staying idle. While a user may still be working on the computer when staying idle (i.e. reviewing a document), it is not possible for a user to work on the computer when the screen saver mode kick in. The one minute setting is the default value and can be customized by system administrator. While the real time view 300 is extremely helpful to monitor the current user computer usage, manager need the historical view to review the past user computer usage.

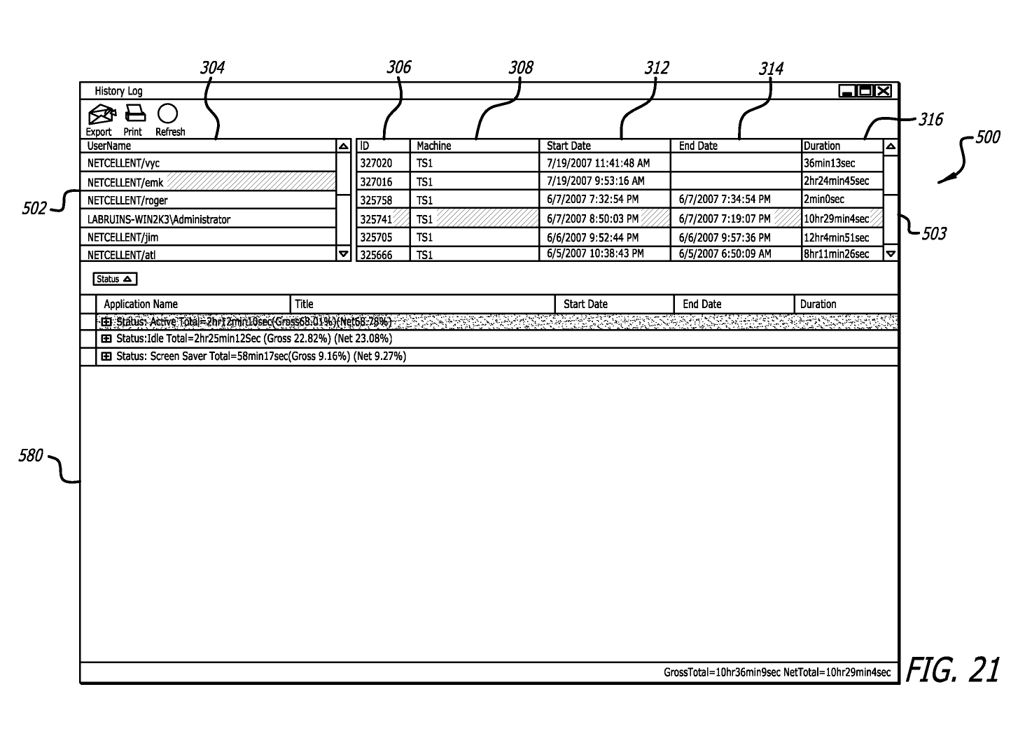

With reference to FIG. 21, the historical view screen 500 offers the option of providing summaries and statistics of the data. In the example of FIG. 21, user can drag the column “Status” to the top of window pane 580, then the data is summarized by status in the bottom window pane 580 with a tree view user interface. The user can expand a portion of the summary, for example, “Active,” to see detail for the user for the selected statistic. In this summary view by “Status”, the manager can easily see how much time a user session stay active, idle or screen saver. Manager can use other users in similar position to establish a base line for performance expectation of the active time or percentage. A lower amount of active time by a user than the peer may indicate the user is less focus with his/her computer. While a performance measurement by other quantifiable method may be a better solution, in many cases, manager may not easily establish quantifiable performance measurable method. Therefore, the “Active Computer Usage Time” may be used as a useful performance measure tool.

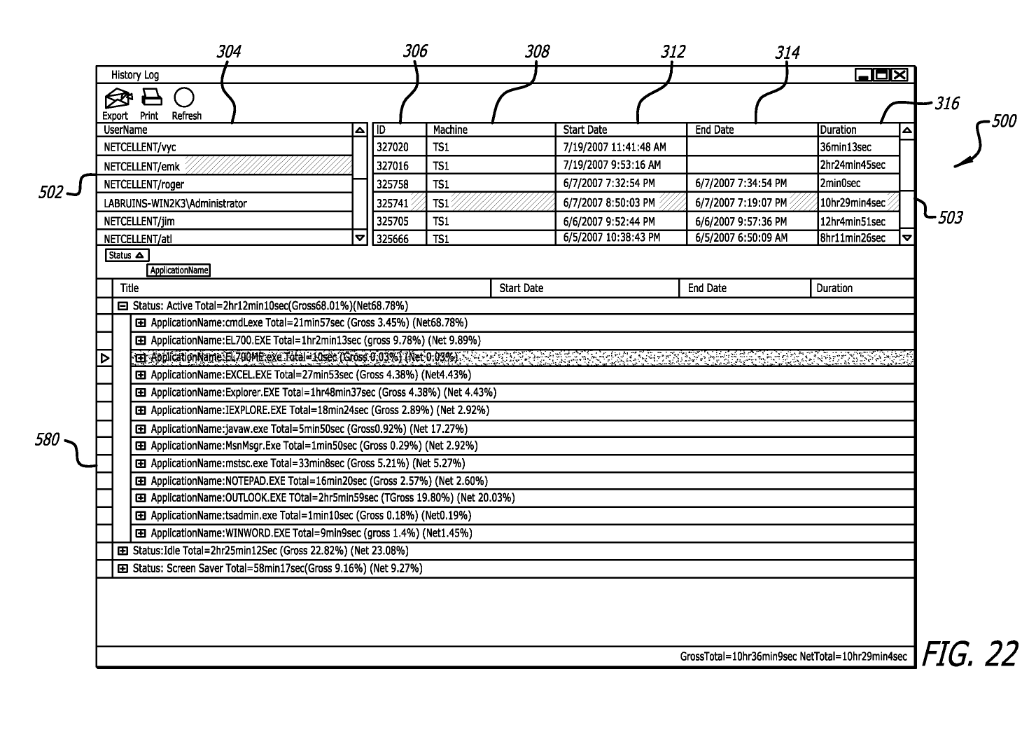

With reference to FIG. 22, a screen that results from the user first drag “Status” column to Window pane 580, then drag “Application Name”. This result in a tree view summarization by Status, then Application in Window pane 580. Then user chooses to expand the Active status node. That result in the Application summarization show under the Active Status. For example, a manager may interest to know how much time a user is actively using Internet Explorer (application name is “IEXPLORE.EXE”). Just knowing a user staying active on computer may not be enough for performance measurement purpose since a user can stay active on computer and browse the Internet for things that not related to their works.

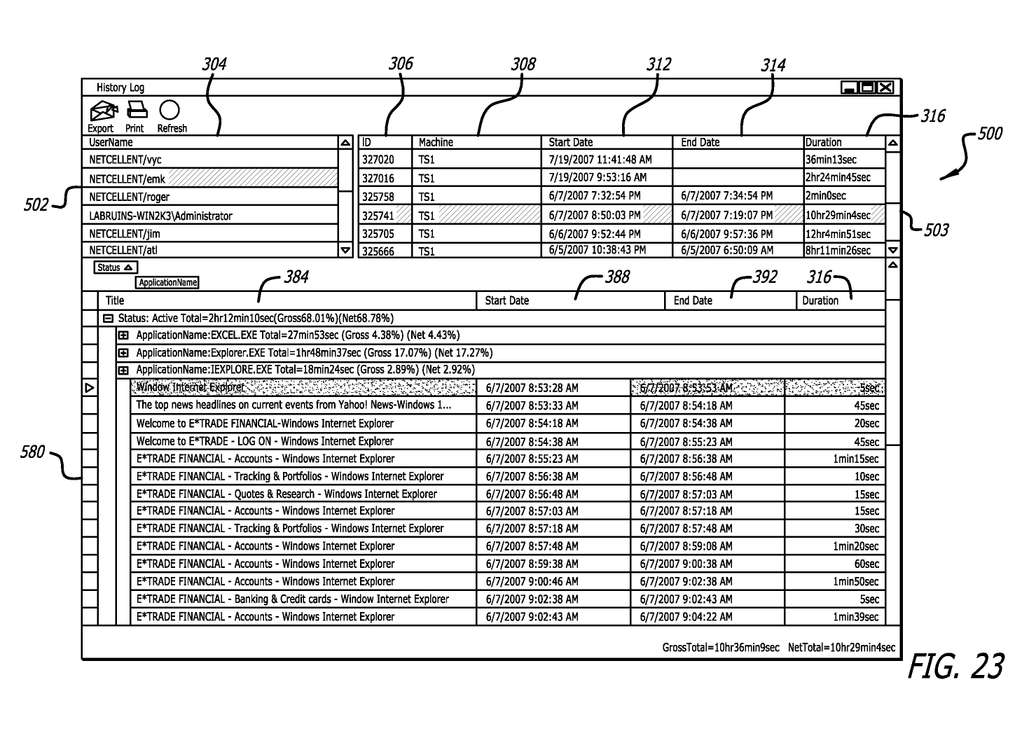

With reference to FIG. 23, the screen that results from expanding the “IEXPLORE.EXE” node in FIG. 22. Since a user may have legitimate reasons to use the Internet, it is necessary to see what websites they visit to judge if their usage of Internet is productive or not. In this example, the Windows Title is displayed and showing the user has been visiting “E*TRADE” website. The manager can then determine if this is a productive usage of computer. The user can click on the top of any of the columns 384, 388, 392 or 316 to sort the records by the selected column.

In each of the above-described screens, the usage statistics are provided as gross and net. The gross time is the accumulation total of each individual entries log in the system. The net times represent the ending time minus the starting time based on the session login and logout time. As a result, the net time is actual total user session time, while the gross total may have rounding errors. Furthermore, manager can highlight multiple entries in window pane 503 to aggregate the weekly or monthly total for comparison. Since a user can login multiple sessions at the same time, the net total time will eliminate overlap time and result in true user session time without duplicate. A user may, for example, login on their regular workstation, then login in the conference room and result in two sessions overlapping. Net time will not count the overlapping time while gross total will.

In each of the above-described screen, the Date Time is stored internally as the Earth standard time (Greenwich Time) to avoid calculation mistake due to time zone difference. When manager use the Session Audit Manager (SAM) to view the user computer usage, the date time will be converted to location's local time zone.

In one embodiment, when the SAM 200 receives a user's window change data, it calculates a user's net total time for one or multiple user sessions. This is performed by calculating the time periods of each user session for a user using the login time and the logout time for each session. However, some users leave their computers logged in at work, and may cause erroneous timer of user periods. In this regard, the SAA 122 treats a user's session as being logged out. If after polling a user session for a certain period, for example, for one hour or eight hours, then the SAA 122 adds a logout record to the window change event log file 132. In one embodiment, the SAA 122 actual does perform an automatic logout of the user from the workstation 110. If the user begins to typing or using the computer again, then a login record is created to indicate beginning of a new session.

Using the three tier architecture described above, namely the SAA 122, SAS 172, SAWS 192, the SAA 122 does not need to have direct access to Internet. It can execute on an in-house workstation 110 that's connected to the local area network 110 but have no Internet access. The SAA 122 operate, for example, on a travelling salesman's notebook computer, and only connect to the network once in a while to transfer the window change data over the Internet 10 to the SAS 172 or directly to the SAWS 192. The separation of the SAS 172 and SAWS 192 allows the system to be hosted with a service provider so the user does not need to worry about backend database and website maintenance.

Further, in one embodiment, the SAM 200 can be used to view what a specific user in a specific location on a specific workstation 110 is doing in real time. The SAA's 122 polling time to can be adjusted to a desired rate to provide more or less real-time viewing. Alternatively, the database storage performed by the SAA 122, SAS 172, and SAWS 192 allows historical views and analysis of the windows change data.

Further, in one embodiment, the SAA 122 establishes a heartbeat with SAS 172. When SAS does not hear from SAA for more than five minutes, it considers the SAA is disconnected and report disconnection status to SAWS 192. When manager utilize SAM 200 for real time view, manager can see the user session that's currently disconnected. The five minutes time out is configurable by the administrator.

Further, in one embodiment, the SAS 172 establishes a heartbeat with SAWS 192. If SAWS does not hear from SAS for more than 15 minutes, it considers the SAS is disconnected and record disconnection status in the database. When manager utilize SAM 200 for real time view, manager can see the user session that's currently disconnected. The 15 minutes time out is configurable by the administrator.

In one embodiment, the SAA 122 identifies a “main window” opened by the user, regardless whether it is Have Focus or not. In this embodiment, there are certain criteria for determining what is the “main window” currently open in a user's session. By way of example, and not by way of limitation, the “main window” can be determined by collecting the viewable size of the each window, whether the window is in focus of a user's session or not. The viewable size can be compared to the total screen resolution of the user's workstation. The size verses resolution ratio can then be determined and recorded to determine if the user is reading from an out of focus application or browser window. This data is stored in the window change event log file 132, so as to report to the SAM 200 that can, for example, sort the user's session windows in reverse sequence of viewable size for out of focus application. This function only need to run once in a while to check if any user is playing game of trying to defeat the system by opening up a browser to a non-productive site, then open a productive application in focus and make the productive application window size small without obstruct the out of focus browser window. This issue is described in U.S. Pat. No. 6,978,303 for the needs to capture all viewable windows. However, U.S. Pat. No. 6,978,303 did not offer a solution to easily identify this kind of problem since scanning through all viewable windows not in focus is not a very productive way for manager to spend their time. By capturing the Viewable Percentage of the not in focus window and allow system to report not in focus window and sort by descending sequence of the Viewable Percentage, the manager can set a threshold like “50%” as a potential problem to focus on.

In one embodiment, a variety of information is collected and stored in the window change event log file 132. For example, if the SAA 132 determines a window to comprise an Internet browser, the SAA 122, in this embodiment, collects the uniform resource locator (URL) currently being viewed, each time the browser is opened or the URL is changed. Further, the application title can be stored, whether the application is a browser or other type of application.

In another embodiment, during analysis of the data, the SAM 200 draws information from each user's calendar schedule, or a general work schedule for all employees or workers. Some users may work part time while others work full time. In addition, some users may take vacation or sick leave during a period where manager try to compare performance, it is necessary for manager to compare base on the percentage of total scheduled work hours instead of the total hours. The system can also compare a user's work schedule to the most often used applications during their the hours of their work day, for example, comparing productivity in the morning to the afternoon. In one embodiment, the SAM 200 keeps a list of approved applications on a user-by-user bases.

For example, some users do not have job descriptions that require them to use the internet excessively. A ratio can be set to flag these users if they use the internet more than a certain amount of time on average each hour, or each day over time. However, this may not apply to other uses who, for example, may have a job that requires them to perform research on the internet. Still, a list of approved web sites by window title or URL may be provided to the SAM 200 in one embodiment, to further add granularity to check a user's Internet use. The SAM automatically highlights users who visit unauthorized web sites more than a set percentage of the time.

In one embodiment, the list of approved applications can be based on a user's department. This is especially helpful with regard to large companies that have 100s or 1000s of employees, making it impossible to determine approved and disapproved applications and web sites for each individual user. If a user goes over a managerial-set ratio of disapproved applications or websites, or uses other applications or websites that are not on the approved list more than a set ratio of their work time, this user can be flagged by the SAM 200 in a report or on-screen.

In one embodiment, a productivity flag is set to determine if the user has a certain number of hours below productive hours among the active hours of their work. In this regard, the SAM 200 uses a general rule of examining the name of the executable file first. If the executable file is one that is not approved for use for the user's department or job category, then the system checks an exception list to determine if a user has been individually allowed to use the application as rule to override to the approved/disapproved application's rule. If the SAM 200 determines that there is not an exception to a non-approved or disapproved application, then SAM 200 uses “keyword” rules to identify none-productive activity. The SAM 200 finds that the window title or URL for the application contains keywords that indicate an approved application then the SAM 200 does not flag the user's record in the database as indicating non-productive activity. For example, if an accountant uses non-approved application Internet Explorer, but the window titles or URLs contain accountant-related keywords (like “Bank of America” which is needed for accountant to perform on-line banking), then the SAM 200 consider this is a productive usage of computer. However, if the accountant visits web sites where keywords are not found in the window titles or URLs, then SAM 200 consider this is non-productive usage of the computer, and the manager can then obtain more detailed reports on the specific user.

The SAA 122 can store further information related to comparisons of user productivity. For example, the SAA 122 can keep a count of the number of keystrokes and mouse clicks between polling times as another factor of performance comparison. This information is stored with each record of the window change event log file 132. Total keystrokes over time can then be compared to the average of other users in the same department or job so a manager can further use this as a measurement for productivity.

In one embodiment, when the when the SAA 122 detect an idle time where no keystrokes or mouse movements are made for a threshold of one minute, the SAA 122 records a system idle record the one minute time frame. In some embodiments, this time frame is extended to five minutes for example, or any other time period the manager wished to configure. When the user starts to type or move the mouse again, or cause another type of input such as voice recognized typing, then an active record is recorded. Similarly, the system records an records for activation and deactivation of the screen saver, which is deemed to be an inactive time period.

In one embodiment, the SAM 200 calculates the active and inactive time periods for each user. The SAM 200 also calculates the active time period over the net total time period for a user to determine an average of active time over the net total timer period for each user. Further, the SAM 200 has the work schedule for each user in the database such that the active time over the work time to get an average active time per work hour, or day, etc. Vacation, holidays, and sick time is taken into account by removing them from the calculation.

In one embodiment, the SAA 122 is a MICROSOFT WINDOWS® Application. In another embodiment, the SAA 122 is a MICROSOFT WINDOWS® service. Further, in one embodiment, the SAA 122 uses the above-described polling method to detect new, changed and closed applications and windows. In another embodiment, a subscribe model is used. For example, the SAA 122 in this embodiment uses the WINDOWS® WM_Create and WM_Destroy type API calls to detect opening, closing, and changing of applications and windows. This changes the system from a polling system to a trigger-based system that detects events to record in the window change event log file 132. To implement SAA's 122 to use subscribe model as described in U.S. Pat. No. 5,675,510 may result in less CPU cycles and more accurate time measurement than polling model.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claim.

1. A system for managing user session usage on one or more network devices, comprising:
a session audit agent executing on each of the one or more network devices for collecting application usage data;
a session audit services application executing on the one or more network devices for receiving the application usage data from each session audit agent;
a session audit web service system executing on a web server capable of receiving the application usage data from the session audit service;
a session audit manager (SAM) for receiving the application usage data from the session audit web service; and
one or more session usage audit tools provided as part of the session audit manager for monitoring and analyzing user session usage of the one or more network devices.

2. The system of claim 1, wherein the session audit agent is located on a computing device connected to a network of attached network devices.

3. The system of claim 2, wherein the web server is located remotely from the network of attached network devices, wherein the application usage data is received from the session audit service by the session audit web service over the Internet.

4. The system of claim 3, wherein the session audit manager executes on a computer that is remotely from the web server, wherein the application usage data is received from the session audit web service by the session audit manager over the Internet.

5. The system of claim 1, comprising a database for storing the application usage data.

6. The system of claim 5, the database further comprising approved application data.

7. The system of claim 6, wherein the session audit manager comprises executable instructions for comparing the application usage data to the approved application data.

8. The system of claim 5, wherein the application usage data includes time stamps for determining time usage of each application, and for determining the time each user of each network device is using approved applications verses the time each user is not using approved applications.

9. The system of claim 5, the database further comprising approved web site keywords.

10. The system of claim 9, wherein the session audit manager comprises executable instructions for comparing the application web site keywords to the uniform resource locator of web pages visited.

11. The system of claim 9, wherein the session audit manager comprises executable instructions for comparing the application web site keywords to the title of web pages visited.

12. The system of claim 11, wherein the application usage data includes time stamps for determining time usage of each web page, and for determining the time each user of each network device is using approved web pages verses the time each user is not using approved web pages.

13. The system of claim 1, wherein the application usage data includes login and logout timestamps for each user session.

14. The system of claim 13, wherein the session audit agent includes executable instructions to automatically set a logout timestamp after a period of inactivity during a user session.

15. The system of claim 14, wherein the SAM includes executable instructions to calculate application usage percentages based on the login and logout times.

16. The system of claim 1, wherein the SAM provides real-time view of the application usage data.

17. The system of claim 1, wherein the SAM provides a historical view of the application usage data.

18. The system of claim 1, wherein the application usage data includes time of focus information for each application and web page used by a user.

19. The system of claim 1, wherein the application usage data includes window size and screen resolution information for each application and web page used by a user.

20. The system of claim 19, wherein the SAM contains executable instructions to determine a main window during a time period of a user session based on the window size verses the screen resolution for each application and web page.

21. The system of claim 1, wherein one of the system audit tools comprises executable instructions for calculating a net total time for a user.

22. The system of claim 21, wherein the net total time comprises a calculation performed by the SAM to eliminate overlap from a user using two or more computer devices at a time, wherein the instructions are configured to subtract overlap time for simultaneous sessions for the same user.

23. The system of claim 22, wherein one of the system audit tools comprises executable instructions for calculating an average productive time, wherein the average productive time is a time in which a user is in productive applications over the net total time.

24. The system of claim 23, wherein the average productive time is the productive time over a number of hours worked by a user during a period of time, minus time for illness, vacation, and holidays.

24. The system of claim 1, wherein one of the system audit tools comprises executable instructions to determine productive time for a user, wherein the productive time comprises time that the SAM determines that a user is using productive software applications.

25. A method for managing user session usage on one or more network devices, comprising:
executing a system audit agent on each of the one or more network devices for collecting application usage data;
executing a session audit services application on the one or more network devices for receiving the application usage data from each session audit agent;
executing a session audit web service system on a web server capable of receiving the application usage data from the session audit service;
executing a session audit manager (SAM) for receiving the application usage data from the session audit web service; and
providing one or more session usage audit tools as part of the session audit manager for monitoring and analyzing user session usage of the one or more network devices.

26. The method of claim 25, wherein the session audit agent is located on a computing device connected to a network of attached network devices.

27. The method of claim 26, wherein the web server is located remotely from the network of attached network devices, wherein the application usage data is received from the session audit agent by the session audit web service over the Internet.

28. The method of claim 27, wherein the session audit manager executes on a computer that is remotely from the web server, wherein the application usage data is received from the session audit web service by the session audit manager over the Internet.

29. The method of claim 25, comprising storing application usage data in a database.

30. The method of claim 29, the database comprising approved application data.

31. The method of claim 30, comprising comparing the application usage data to the approved application data.

32. The method of claim 31, wherein the application usage data includes time stamps for determining time usage of each application, and for determining the time each user of each network device is using approved applications verses the time each user is not using approved applications.

33. The method of claim 32, the database further comprising approved web site keywords.

34. The method of claim 33, wherein the session audit manager comprises executable instructions for comparing the application web site keywords to uniform resource locators of web pages visited.

35. The method of claim 33, wherein the session audit manager comprises executable instructions for comparing the application web site keywords to titles of web pages visited.

36. The method of claim 35, wherein the application usage data includes time stamps for determining time usage of each web page, and for determining the time each user of each network device is using approved web pages verses the time each user is not using approved web pages.

37. The method of claim 25, wherein the application usage data includes login and logout timestamps for each user session.

38. The method of claim 37, wherein the session audit agent includes executable instructions to automatically set a logout timestamp after a period of inactivity during a user session.

39. The method of claim 38, wherein the SAM includes executable instructions to calculate application usage percentages based on the login and logout times.

40. The method of claim 25, wherein the SAM provides real-time view of the application usage data.

41. The method of claim 40, wherein the SAM provides a historical view of the application usage data.

42. The method of claim 41, wherein the application usage data includes time of focus information for each application and web page used by a user.

43. The method of claim 42, wherein the application usage data includes window size and screen resolution information for each application and web page used by a user.

44. The method of claim 43, wherein the SAM contains executable instructions to determine a main window during a time period of a user session based on the window size verses the screen resolution for each application and web page.

45. The method of claim 25, wherein one of the system audit tools comprises executable instructions for calculating a net total time for a user.

46. The method of claim 45, wherein the net total time comprises a calculation performed by the SAM to eliminate overlap from a user using two or more computer devices at a time, wherein the instructions are configured to subtract overlap time for simultaneous sessions for the same user.

47. The method of claim 46, wherein the session audit tools comprises executable instructions to determine productive time for a user, wherein the productive time comprises time that the SAM determines that a user is using productive software applications.

48. The method of claim 47, wherein one of the system audit tools comprises executable instructions for calculating an average productive time, wherein the average productive time is a productive time over the net total time.

49. The method of claim 48, wherein the average productive time is the productive time over a number of hours worked by a user during a period of time, minus time for illness, vacation, and holidays.

50. A set of executable instructions stored in a computer readable medium, configured to perform the following steps:
executing a session audit agent on each of the one or more network devices for collecting application usage data;
executing a session audit services application on the one or more network devices for receiving the application usage data from each session audit agent;
executing a session audit web service system on a web server capable of receiving the application usage data from the session audit service;
executing a session audit manager (SAM) for receiving the application usage data from the session audit web service; and
providing one or more session usage audit tools as part of the session audit manager for monitoring and analyzing user session usage of the one or more network devices.

51. A system for managing usage on one or more network devices, comprising:
a first process executing on each of the one or more network devices for collecting application usage data;
a second process executing on the one or more network devices for receiving the application usage data from each session audit agent;
a third process for executing on the one or more network devices for receiving the application usage data from the session audit service;
a forth process for receiving the application usage data on the one or more network devices; and
one or more audit tools provided for monitoring and analyzing usage of the one or more network devices.
